(19) United States
(12) Patent Application Publication
(10) Pub. No.: US 2026/0217192 A1
(43) Pub. Date: Jul. 30, 2026

(54) IN-VEHICLE SYSTEM AND INFORMATION PROCESSING DEVICE

(71) Applicant: TOYOTA JIDOSHA KABUSHIKI KAISHA, Toyota-shi, (JP)

(72) Inventors: Hirotake SANO, Nagakute-shi (JP); Takashi OSAWA, Toyota-shi (JP); Ryota HAMABE, Nisshin-shi (JP); Miki TSUJINO, Ichinomiya-shi (JP); Shintaro MATSUTANI, Kariya-shi (JP); Hisashi FUJIWARA, Nisshin-shi (JP)

(73) Assignee: TOYOTA JIDOSHA KABUSHIKI KAISHA, Toyota-shi (JP)

(21) Appl. No.: 19/437,447

(22) Filed: Dec. 31, 2025

(30) Foreign Application Priority Data
Jan. 30, 2025 (JP) 2025-014159

(51) Int. Cl. B60R 1/25; B60K 35/10

(52) U.S. Cl. CPC B60R 1/25; B60K 35/10; B60K 2360/1438; B60K 2360/1468; B60R 2300/105

(57) ABSTRACT

An in-vehicle system includes an electronic sideview mirror device, a display device, and an information processing device. The information processing device includes a controller configured to execute transmitting, to the display device, a command for displaying a target image that is one of the sideview mirror images of the electronic sideview mirror device on a target display that is one of the second displays, receiving, from the touch panel, a signal about a touch operation on a screen of the target display in a state where the target image is displayed on the target display, and transmitting, to the electronic sideview mirror device, a command for changing the target image to an image according to the touch operation.

### CROSS-REFERENCE TO RELATED APPLICATION

This application claims priority to Japanese Patent Application No. 2025-014159 filed on January 30, 2025. The disclosure of the above-identified application, including the specification, drawings, and claims, is incorporated by reference herein in its entirety.

### BACKGROUND

### Technical Field

The present disclosure relates to an in-vehicle system and an information processing device.

### Description of Related Art

There is a known technology in which a touch panel is provided in an electronic inner mirror (electronic rearview mirror) that displays an image of a camera photographing a vehicle rear side, and scrolling, scaling up, scaling down, adjustment of brightness, etc., are performed on the image displayed on the electronic inner mirror according to a touch operation input into the touch panel (e.g., see Japanese Unexamined Patent Application Publication No. 2018-103866 (JP 2018-103866 A)).

### SUMMARY

The present disclosure provides an in-vehicle system and an information processing device that can improve the operability of an electronic sideview mirror device installed in a vehicle.

An in-vehicle system according to a first aspect of the present disclosure includes an electronic sideview mirror device, a display device, and an information processing device. The electronic sideview mirror device includes a pair of side cameras configured to photograph right and left rear sides of a vehicle, and a pair of first displays configured to respectively display a pair of sideview mirror images photographed by the side cameras. The display device includes a pair of second displays. The second displays are respectively disposed on lateral sides of a steering wheel so as to protrude farther toward a vehicle rear side than an instrument unit placed on a front side of the steering wheel, and each of the second displays has a touch panel. The information processing device includes a controller. The controller is configured to execute transmitting, to the display device, a command for displaying a target image that is one of the sideview mirror images on a target display that is one of the second displays, receiving, from the touch panel, a signal about a touch operation on a screen of the target display in a state where the target image is displayed on the target display, and transmitting, to the electronic sideview mirror device, a command for changing the target image to an image according to the touch operation.

An in-vehicle system according to a second aspect of the present disclosure includes an electronic sideview mirror device, a display device, and an information processing device. The electronic sideview mirror device includes a pair of side cameras configured to photograph right and left rear sides of a vehicle, and a pair of first displays configured to respectively display a pair of sideview mirror images photographed by the side cameras. The display device includes a pair of second displays. The second displays are respectively disposed on lateral sides of a steering wheel so as to protrude farther toward a vehicle rear side than an instrument unit placed on a front side of the steering wheel, and each of the second displays has a touch panel. The information processing device includes a controller. The controller is configured to execute displaying a target image that is one of the sideview mirror images on a target display that is one of the second displays, detecting a touch operation on a screen of the target display in a state where the target image is displayed on the target display, and changing the target image to an image according to the touch operation.

In the in-vehicle system according to the second aspect of the present disclosure, the touch operation may be an operation of touching a region in the screen of the target display other than a center. The changing of the target image to the image according to the touch operation may include: determining a touch direction that is a direction in which a position that has received the touch operation is located with respect to the center in the screen of the target display; and transmitting, to the electronic sideview mirror device, a command for moving a photographing direction of the target image to the touch direction.

In the in-vehicle system according to the second aspect of the present disclosure, the touch operation may be an operation of swiping on the screen of the target display. The changing of the target image to the image according to the touch operation may include determining a sliding direction of the touch operation, and transmitting, to the electronic sideview mirror device, a command for moving a photographing direction of the target image to an opposite direction from the sliding direction.

In the in-vehicle system according to the second aspect of the present disclosure, the displaying of the target image on the target display may include displaying an image in which two or more graphical user interface (GUI) parts for changing a photographing direction of the target image are superimposed on the target image. The touch operation may be an operation of touching one of the two or more GUI parts. The changing of the target image to the image according to the touch operation may include determining the GUI part that has been selected by the touch operation, and transmitting, to the electronic sideview mirror device, a command for moving the photographing direction of the target image to a direction corresponding to the determined GUI part.

In the in-vehicle system according to the second aspect of the present disclosure, the touch operation may be an operation of pinching in or pinching out on the screen of the target display. The changing of the target image to the image according to the touch operation may include determining an operation amount of the pinching in or the pinching out, and transmitting, to the electronic sideview mirror device, a command for increasing or reducing an angle of view of the target image to an angle of view according to the determined operation amount.

In the in-vehicle system according to the second aspect of the present disclosure, the information processing device may further include a memory configured to contain reverse interlock information. The reverse interlock information may be information about on or off of reverse interlock that switches the target image to an image for reversing in response to a shift position of the vehicle having been changed to a reverse range. The controller may be configured to further execute: displaying a screen for selecting on or off of the reverse interlock on one of the second displays; and storing a selection result of on or off of the reverse interlock in the memory as the reverse interlock information.

An information processing device according to a third aspect of the present disclosure is installed in a vehicle and includes a controller. The vehicle includes an electronic sideview mirror device and a display device. The electronic sideview mirror device includes a pair of side cameras configured to photograph right and left rear sides of the vehicle, and a pair of first displays configured to respectively display a pair of sideview mirror images photographed by the side cameras. The display device includes a pair of second displays. The second displays are respectively disposed on lateral sides of a steering wheel so as to protrude farther toward a vehicle rear side than an instrument unit placed on a front side of the steering wheel, and each of the second displays has a touch panel. The information processing device includes a controller. The controller is configured to execute displaying a target image that is one of the sideview mirror images on a target display that is one of the second displays, detecting a touch operation on a screen of the target display, and changing the target image to an image according to the touch operation.

In the information processing device according to the third aspect of the present disclosure, the touch operation may be an operation of touching a region in the screen of the target display other than a center. The changing of the target image to the image according to the touch operation may include: determining a touch direction that is a direction in which a position that has received the touch operation is located with respect to the center in the screen of the target display; and transmitting, to the electronic sideview mirror device, a command for moving a photographing direction of the target image to the touch direction.

In the information processing device according to the third aspect of the present disclosure, the touch operation may be an operation of swiping on the screen of the target display. The changing of the target image to the image according to the touch operation may include determining a sliding direction of the touch operation, and transmitting, to the electronic sideview mirror device, a command for moving a photographing direction of the target image to an opposite direction from the sliding direction.

In the information processing device according to the third aspect of the present disclosure, the displaying of the target image on the target display may include displaying an image in which two or more graphical user interface (GUI) parts for changing a photographing direction of the target image are superimposed on the target image. The touch operation may be an operation of touching one of the two or more GUI parts. The changing of the target image to the image according to the touch operation may include determining the GUI part that has been selected by the touch operation, and transmitting, to the electronic sideview mirror device, a command for moving the photographing direction of the target image to a direction corresponding to the determined GUI part.

In the information processing device according to the third aspect of the present disclosure, the touch operation may be an operation of pinching in or pinching out on the screen of the target display. The changing of the target image to the image according to the touch operation may include determining an operation amount of the pinching in or the pinching out, and transmitting, to the electronic sideview mirror device, a command for increasing or reducing an angle of view of the target image to an angle of view according to the determined operation amount.

The information processing device according to the third aspect of the present disclosure may further include a memory configured to contain reverse interlock information. The reverse interlock information may be information about on or off of reverse interlock that switches the target image to an image for reversing in response to a shift position of the vehicle having been changed to a reverse range. The controller may be configured to further execute: displaying a screen for selecting on or off of the reverse interlock on one of the second displays; and storing a selection result of on or off of the reverse interlock in the memory as the reverse interlock information.

Other aspects of the present disclosure are a vehicle equipped with the above-described in-vehicle system, an information processing method that is executed by the above-described information processing device, a program that makes a computer execute that information processing method, and a computer-readable storage medium that non-transitorily stores that program.

The present disclosure can provide a technology that can improve the operability of an electronic sideview mirror device installed in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing one example of a layout inside a vehicle cabin in an embodiment;

FIG. 2 is a plan view showing one example of an external appearance of a vehicle in the embodiment;

FIG. 3 is a view showing one example of a simplified configuration of a display device and its surroundings in the embodiment;

FIG. 4 is a view schematically showing one example of a hardware configuration of the vehicle in the embodiment;

FIG. 5 is a block diagram showing one example of a software configuration of an ECU in the embodiment;

FIG. 6 is a view showing one example of a setting screen of an electronic sideview mirror device that is displayed on an outer display in the embodiment;

FIG. 7 is a view showing one example of an adjustment screen for a left sideview mirror image that is displayed on an inner display in the embodiment;

FIG. 8 is a view showing one example of dividing a display region of a target image in FIG. 7 into a plurality of touch regions;

FIG. 9 is a flowchart showing one example of a processing routine that is executed in the ECU in the embodiment;

FIG. 10 is a view showing one example of an adjustment screen for the left sideview mirror image that is displayed on the inner display in Modified Example 1;

FIG. 11 is a flowchart showing one example of a processing routine that is executed in the ECU in Modified Example 1;

FIG. 12 is a view showing an example of changing a photographing direction of the left sideview mirror image according to a swiping operation performed on an adjustment screen for the left sideview mirror image that is displayed on the inner display in Modified Example 2;

FIG. 13 is a flowchart showing one example of a processing routine that is executed in the ECU in Modified Example 2;

FIG. 14 is a flowchart showing one example of a processing routine that is executed in the ECU in Modified Example 3;

FIG. 15 is a view showing one example of a setting screen of the electronic sideview mirror device that is displayed on the outer display in Modified Example 6;

FIG. 16 is a block diagram showing one example of the software configuration of the ECU in Modified Example 6; and

FIG. 17 is a view schematically showing one example of reverse interlock information in Modified Example 6.

### DETAILED DESCRIPTION OF EMBODIMENTS

There is a known vehicle that is equipped with an electronic sideview mirror device in place of a pair of optical sideview mirrors (door mirrors, fender mirrors, etc.) that is provided on exterior parts on right and left sides of the vehicle. The electronic sideview mirror device is configured to include a pair of side cameras that is provided on exterior parts on the right and left sides of the vehicle, and a pair of first display units that is provided inside a cabin of the vehicle and respectively displays sideview mirror images photographed by the side cameras. In one example, the first display units are respectively disposed near right and left ends of a dashboard, and the left-side first display unit displays a left-side sideview mirror image and the right-side first display unit displays a right-side sideview mirror image. Compared with optical sideview mirrors, such an electronic sideview mirror device can keep down the amount of movement of the driver's line of sight and enhance the visibility at night or in rainy weather.

Here, as a method of manipulating (adjusting) the photographing direction (the direction of the camera), the angle of view, etc., of the sideview mirror image displayed on the first display unit, a conceivable method is to provide a manipulation switch near the driver seat and adjust the photographing direction, the angle of view, etc., by manipulating this manipulation switch. In this method, it may be difficult to intuitively manipulate the manipulation switch or finely adjust the photographing direction, the angle of view, etc. In view of this, another conceivable method is to provide a touch panel in the first display unit and adjust the photographing direction, the angle of view, etc., by performing a touch operation on this touch panel. However, while the first display unit of the right and left first display units that is disposed on the driver seat side is disposed near the driver seat and therefore is easy for the driver to perform a touch operation thereon in a state of being seated in the driver seat, the first display unit that is disposed on the front passenger seat side is disposed at a position away from the driver seat and therefore is difficult for the driver to perform a touch operation thereon in the state of being seated in the driver seat. Thus, some measures for improving the operability of the electronic sideview mirror device are needed.

As a solution, in the in-vehicle system according to the present disclosure, the same image as the image that is displayed on the first display unit is displayed on a second display unit that is disposed near the steering wheel to thereby allow the driver to adjust the photographing direction and/or the angle of view, etc., by performing a touch operation on a screen of the second display unit. Specifically, the in-vehicle system according to the present disclosure is configured to include an electronic sideview mirror device, a display device, and an information processing device.

The electronic sideview mirror device is configured to include a pair of side cameras and a pair of first display units. In one example, the side cameras are provided on exterior parts (e.g., front door panels, front fender panels, etc.) on right and left sides of the vehicle and respectively photograph the right rear side and the left rear side of the vehicle. In one example, the first display units are respectively disposed on interior parts (e.g., a dashboard, linings of front pillars, linings of front doors, etc.) near right and left ends of the dashboard inside the cabin of the vehicle, and respectively display a pair of sideview mirror images photographed by the side cameras.

The display device is configured to include a pair of second display units that is disposed near the steering wheel. In one example, the second display units are respectively disposed on lateral sides of the steering wheel so as to protrude farther toward a vehicle rear side than an instrument unit placed on a front side of the steering wheel, and each have a touch panel.

The information processing device is a computer that executes information processing relating to adjustment of the photographing direction (the direction of the side camera) and/or the angle of view, etc., of the sideview mirror image displayed on the first display unit. In one example, the information processing device may be an electronic control unit (ECU) installed in the vehicle. The information processing device according to the present disclosure is configured to include a controller.

The controller of the information processing device according to the present disclosure is configured to display a target image that is one of the sideview mirror images on a target display unit that is one of the second display units. In this case, when the target image is the sideview mirror image displayed on the right-side first display unit (the sideview mirror image photographed by the right-side side camera), the target display unit may be the second display unit that is disposed on the right side of the steering wheel. When the target image is the sideview mirror image that is displayed on the left-side first display unit (the sideview mirror image photographed by the left-side side camera), the target display unit may be the second display unit that is disposed on the left side of the steering wheel.

In one example, the process of displaying the target image on the target display unit may be executed when, as a trigger, a user has performed a special operation. The special operation may be an operation of selecting an item for changing (adjusting) the target image from an operation menu displayed on the second display unit, or may be an operation of a special switch disposed near the driver seat.

The controller of the information processing device according to the present disclosure is configured to detect a touch operation on the screen of the target display unit in a state where the target image is displayed on the target display unit. In one example, the term "touch operation" may include a tapping operation, a long-pressing operation, a swiping operation, a pinching operation, etc. Information about such a touch operation may be transmitted from the touch panel of the display device to the information processing device. The controller of the information processing device can detect the touch operation by receiving this information from the touch panel.

Further, the controller of the information processing device according to the present disclosure is configured to change the target image to an image according to the touch operation upon detecting the touch operation.

Here, the touch operation in the present disclosure may be an operation of touching (e.g., a tapping operation or a long-pressing operation) on a region in the screen of the target display unit other than the center. In that case, changing the target image to the image according to the touch operation may include determining a direction (touch direction) in which the position that has received the touch operation is located with respect to the center in the screen of the target display unit, and transmitting, to the electronic sideview mirror device, a command for moving the photographing direction of the target image to the touch direction. In one example, when the position that has received the touch operation is a position on the right side (or the left side) of the center, the controller may determine the touch direction to be the rightward direction (or the leftward direction). Then, the controller should transmit, to the electronic sideview mirror device, a command for moving the photographing direction of the target image to the rightward direction (or the leftward direction). In another example, when the position that has received the touch operation is a position on the upper side (or the lower side) of the center, the controller may determine the touch direction to be the upward direction (or the downward direction). Then, the controller should transmit, to the electronic sideview mirror device, a command for moving the photographing direction of the target image to the upward direction (or the downward direction). When the position that has received the touch operation is a position on an obliquely right upper side (or an obliquely right lower side) of the center, the controller may determine the touch direction to be an obliquely rightward-upward direction (or an obliquely rightward-downward direction). Then, the controller should transmit, to the electronic sideview mirror device, a command for moving the photographing direction of the target image to the obliquely rightward-upward direction (or the obliquely rightward-downward direction). When the position that has received the touch operation is a position on an obliquely left upper side (or an obliquely left lower side) of the center, the controller may determine the touch direction to be an obliquely leftward-upward direction (or an obliquely leftward-downward direction). Then, the controller should transmit, to the electronic sideview mirror device, a command for moving the photographing direction of the target image to the obliquely leftward-upward direction (or the obliquely leftward-downward direction).

The touch operation in the present disclosure may be an operation of swiping on the screen of the target display unit. In that case, changing the target image to the image according to the touch operation may include determining a sliding direction of the touch operation, and transmitting, to the electronic sideview mirror device, a command for moving the photographing direction of the target image to the opposite direction from the sliding direction. In one example, when the swiping operation is an operation of sliding the touch position in the rightward direction (or the leftward direction), the controller may determine the sliding direction to be the rightward direction (or the leftward direction). Then, the controller should transmit, to the electronic sideview mirror device, a command for moving the photographing direction of the target image to the leftward direction (or the rightward direction) opposite from the sliding direction. In another example, when the swiping operation is an operation of sliding the touch position in the upward direction (or the downward direction), the controller may determine the sliding direction to be the upward direction (or the downward direction). Then, the controller should transmit, to the electronic sideview mirror device, a command for moving the photographing direction of the target image to the downward direction (or the upward direction) opposite from the sliding direction. When the swiping operation is an operation of sliding the touch position in the obliquely rightward-upward direction (or an obliquely rightward-downward direction), the controller may determine the sliding direction to be the obliquely rightward-upward direction (or the obliquely rightward-downward direction). Then, the controller should transmit, to the electronic sideview mirror device, a command for moving the photographing direction of the target image to the obliquely leftward-downward direction (or the obliquely leftward-upward direction) opposite from the sliding direction. When the swiping operation is an operation of sliding the touch position in the obliquely leftward-upward direction (or the obliquely leftward-downward direction), the controller may determine the sliding direction to be the obliquely leftward-upward direction (or the obliquely leftward-downward direction). Then, the controller should transmit, to the electronic sideview mirror device, a command for moving the photographing direction of the target image to the obliquely rightward-downward direction (or the obliquely rightward-upward direction) opposite from the swiping direction.

When displaying the target image on the target display unit, the controller of the information processing device according to the present disclosure may display an image in which two or more graphical user interface (GUI) parts for changing the photographing direction of the target image are superimposed on the target image. The touch operation in that case may be an operation of touching one of the two or more GUI parts. Then, changing the target image to the image according to the touch operation may include determining the GUI part that has been selected by the touch operation, and transmitting, to the electronic sideview mirror device, a command for moving the photographing direction of the target image to a direction corresponding to the determined GUI part.

The touch operation in the present disclosure may be an operation of pinching in or pinching out on the screen of the target display unit. In that case, changing the target image to the image according to the touch operation may include determining an operation amount of pinching in or pinching our, and transmitting, to the electronic sideview mirror device, a command for increasing or reducing the angle of view of the target image to an angle of view according to the determined operation amount.

The in-vehicle system according to the present disclosure allows the driver to adjust the photographing direction, the angle of view, etc., of the target image by performing a touch operation on the screen of the target display unit in the state of being seated in the driver seat. Meanwhile, the sideview mirror image to be adjusted is displayed on the target display unit, so that the driver can adjust the photographing direction, the angle of view, etc., while checking the sideview mirror image from up close. This makes it easy to finely adjust the photographing direction, the angle of view, etc., of the sideview mirror image, and can improve the operability of the electronic sideview mirror device.

In the following, embodiments of the present disclosure will be described based on the drawings. The configurations of the following embodiments are presented as examples, and the present disclosure is not restricted to the configurations of the embodiments. The following embodiments can be combined as far as possible.

### Embodiments

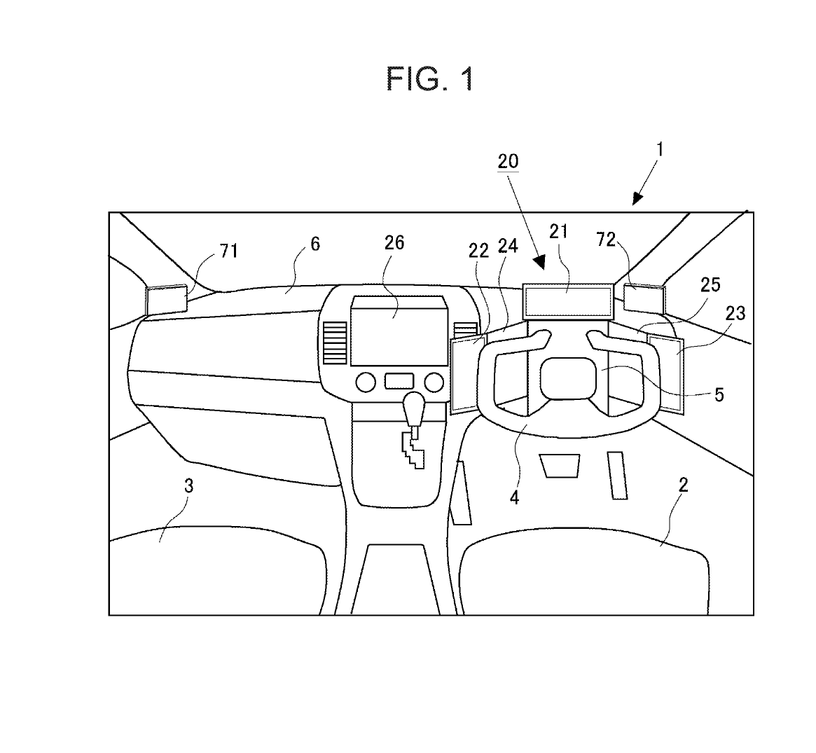

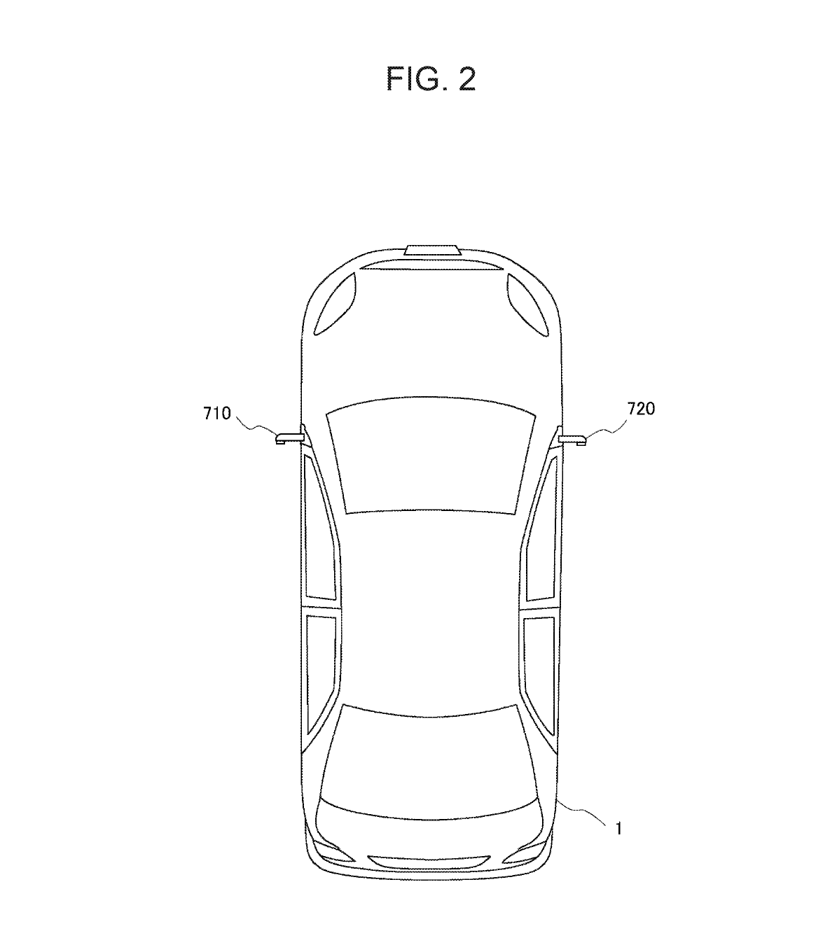

An overview of an in-vehicle system in an embodiment will be described based on FIGS. 1 and 2. FIG. 1 is a view showing one example of a layout inside a cabin of a vehicle 1. FIG. 2 is a plan view of the vehicle 1.

As shown in FIG. 1, a driver seat 2 and a front passenger seat 3 are provided inside the cabin of the vehicle 1. The vehicle 1 of the embodiment is a right-hand drive vehicle, and the driver seat 2 is provided on a right side in a forward direction of the vehicle 1. In front of the driver seat 2, a steering wheel 4 is placed. The steering wheel 4 may be a U-shaped one (a so-called irregular-shaped steering wheel) or may be a circular one. The steering wheel 4 is connected to a steering device belonging to the vehicle 1 through a steering column 5. The steering column 5 is covered by a column cover.

The front passenger seat 3 is provided on a left side of the driver seat 2, and a center display 26 is placed midway between the driver seat 2 and the front passenger seat 3, in front of these seats in a vehicle front-rear direction. The center display 26 is mounted at a central portion of a dashboard 6 in a right-left direction of the vehicle 1 (vehicle width direction).

In front of the steering wheel 4 in the vehicle front-rear direction, a meter display 21 is provided. The meter display 21 is a full-screen display that is located on a front side of the driver seat 2 and provides various information to a driver of the vehicle 1. The meter display 21 is one example of the "instrument unit" in the present disclosure.

A display device 20 is disposed near the steering wheel 4 inside the vehicle cabin. The display device 20 in the embodiment is configured to include an inner display 22 that is located rearward and inward (leftward in FIG. 1) of the meter display 21 in the vehicle 1, an outer display 23 that is located rearward and outward (rightward in FIG. 1) of the meter display 21 in the vehicle 1, an inner bracket 24 that fixes the inner display 22 to the steering column 5, and an outer bracket 25 that fixes the outer display 23 to the steering column 5. The inner display 22 and the outer display 23 are one example of the "second display units" according to the present disclosure.

The outer side of the vehicle 1 means a side closer to an outside of the vehicle 1 as seen from the driver seat 2, and means the side of a door of the driver seat 2. The inner side of the vehicle 1 means the side of the front passenger seat 3 as seen from the driver seat 2, and means the side of a door of the front passenger seat 3. For example, in the vehicle 1 in which the steering wheel is provided on the right side of the vehicle 1, the outer side of the vehicle 1 refers to the right side of the vehicle 1 and the inner side of the vehicle 1 refers to the left side of the vehicle 1. For example, in the vehicle 1 in which the steering wheel 4 is provided on the left side of the vehicle 1, the outer side of the vehicle 1 refers to the left side of the vehicle 1 and the inner side of the vehicle 1 refers to the right side of the vehicle 1. In the vehicle 1 in which the steering wheel is disposed at a center of the vehicle cabin, for example, the outer side and the inner side of the vehicle 1 may be arbitrarily determined.

The inner display 22 and the outer display 23 in the embodiment are both displays having a touch panel (touch panel displays). As the touch panel, for example, a pressure-sensitive touch panel that detects a pressure with which a user presses the panel, or a capacitive touch panel that detects a change in capacitance when a user presses the panel can be adopted. The display is, for example, a liquid crystal display (LCD) or an electroluminescence (EL) panel.

A pair of side displays 71, 72 is disposed near right and left end portions of the dashboard 6 in the vehicle width direction. The side displays 71, 72 are fixed on the dashboard 6. The side displays 71, 72 may be fixed on linings of front pillars, or may be fixed on linings of front doors (the door of the driver seat, the door of the front passenger seat). Hereinafter, the side display 71 disposed near the left-side end portion of the dashboard 6 will be referred to as a "left side display 71," and the side display 72 disposed near the right-side end portion of the dashboard 6 will be referred to as a "right side display 72."

As shown in FIG. 2, a pair of side cameras 710, 720 is mounted on exterior parts of the vehicle 1. In the example shown in FIG. 2, the side cameras 710, 720 are respectively fixed on an exterior part of the door of the driver seat and an exterior part of the door of the front passenger seat. The side cameras 710, 720 may be respectively fixed on a front fender panel on the driver seat side and a front fender panel on the front passenger seat side. In the embodiment, the side cameras 710, 720 are configured to be foldable by an electric actuator. Further, in the embodiment, the side cameras 710, 720 are configured such that, of the direction (photographing direction) and the angle of view thereof, at least the direction can be changed by the electric actuator. Hereinafter, the side camera 710 disposed on the exterior part on the passenger seat side (the left side in FIG. 2) will be referred to as a "left side camera 710," and the side camera 720 disposed on the exterior part on the front driver seat side (the right side in FIG. 2) will be referred to as a "right side camera 720." Hereinafter, a combination of the left side display 71, the left side camera 710, the right side display 72, and the right side camera 720 will be referred to as an "electronic sideview mirror device 70."

### Display Device

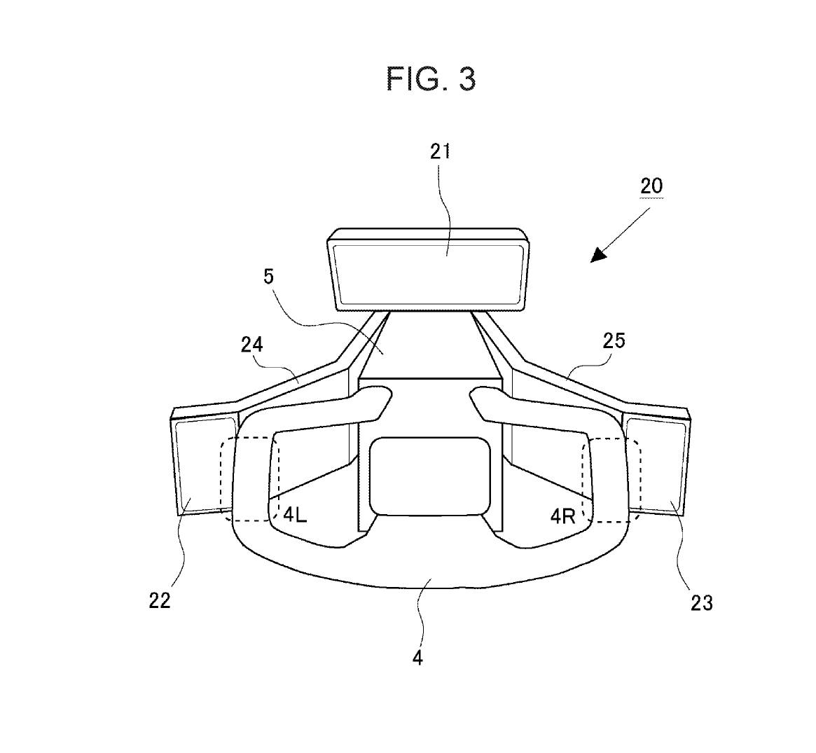

FIG. 3 is a view showing one example of a simplified configuration of the display device 20 and its surroundings. The display device 20 is fixed on the steering column 5. The display device 20 may instead be fixed on the dashboard 6.

On a side surface of the steering column 5 on the vehicle inner side (the left side in FIG. 3), the inner bracket 24 is mounted. The inner bracket 24 is a support member that extends from the side surface of the steering column 5 on the vehicle inner side toward the vehicle rear side as well as the vehicle inner side. The inner display 22 is supported at a leading end portion (an end portion on the vehicle rear side as well as the vehicle inner side) of the inner bracket 24. The inner display 22 is a vertically long display that extends from the leading end portion of the inner bracket 24 toward the rear side of the vehicle 1 as well as the inner side of the vehicle 1. The inner bracket 24 is configured to bend or curve toward the vehicle inner side while extending from the vehicle front side toward the vehicle rear side.

On a side surface of the steering column 5 on the vehicle outer side (the right side in FIG. 3), the outer bracket 25 is mounted. The outer bracket 25 is a member that extends from the side surface of the steering column 5 on the vehicle outer side toward the vehicle rear side as well as the vehicle outer side. The outer display 23 is supported at a leading end portion (an end portion on the vehicle rear side as well as the vehicle outer side) of the outer bracket 25. The outer display 23 is a vertically long display that extends from the leading end portion of the outer bracket 25 toward the vehicle rear side as well as the vehicle outer side. The outer bracket 25 is configured to bend or curve toward the vehicle outer side while extending from the vehicle front side toward the vehicle rear side.

Thus, the inner bracket 24 and the outer bracket 25 are shaped to extend from the side surfaces of the steering column 5 toward the vehicle rear side and, from an intermediate point, bend or curve so as to splay in the vehicle width direction (vehicle right-left direction). Thus, the inner display 22 and the outer display 23 can be disposed near grasped portions of the steering wheel 4.

As shown in FIG. 3, the inner bracket 24 and the outer bracket 25 in the embodiment are configured such that each of the inner display 22 and the outer display 23 has an angle relative to a right-left direction of the steering wheel 4 and is tilted toward the steering wheel 4. Thus, the inner display 22 is disposed so as to, on the inner side of the vehicle 1, protrude farther toward the rear side of the vehicle 1, and the outer display 23 is disposed so as to, on the outer side of the vehicle 1, protrude farther toward the rear side of the vehicle 1. As a result, the screens of the inner display 22 and the outer display 23 can be disposed so as to each face the driver seat 2 of the vehicle 1 (the driver of the vehicle 1).

Here, a region 4L indicated by the broken line in FIG. 3 is a portion at which the steering wheel 4 is grasped by the left hand (grasped portion), and a region 4R indicated by the broken line in FIG. 3 is a portion at which the steering wheel 4 is grasped by the right hand (grasped portion). The inner display 22 and the outer display 23 are disposed frontward of the grasped portions 4L, 4R of the steering wheel 4 in the front-rear direction of the vehicle 1. In this case, configuring the inner bracket 24 and the outer bracket 25 as described above allows the positions of the inner display 22 and the outer display 23 in the vehicle front-rear direction to be set closer to the grasped portions 4L, 4R of the steering wheel 4. This can further reduce the amount of movement of the driver's hand when the driver performs a touch operation on the inner display 22 or the outer display 23 while driving.

In one example, the inner display 22 displays information about convenience for occupants of the vehicle 1 as contents. The information about convenience for occupants may include information for providing entertainment to occupants, and/or information about comfort of occupants, etc. In one example, the contents of the information about convenience for occupants may include GUI parts for performing manipulation of audio equipment, manipulation of a navigation device, manipulation of an air conditioner, manipulation of a telephone, manipulation of a clock, manipulation of a voice assistant, etc., (e.g., GUI parts, such as switches or buttons, for manipulating a device to be manipulated), an operating status of a device to be manipulated, etc.

In one example, the outer display 23 displays information about control of the vehicle 1 as contents. The information about the control of the vehicle 1 may include information about travel of the vehicle 1. In one example, the contents of the information about the control of the vehicle 1 may include GUI parts for performing manipulation of headlights, manipulation of wipers, manipulation of the electronic sideview mirror device 70, manipulation of an ADAS, manipulation of a drive mode, manipulation of a vehicle height, manipulation of the position of the steering wheel, manipulation of the position of an electrically powered seat, etc., (e.g., GUI parts, such as switches or buttons, for manipulating a device to be manipulated), an operating status of a device to be manipulated, etc.

The information to be displayed on the inner display 22 and the outer display 23 is not limited to those mentioned above. The inner display 22 may display information about the control of the vehicle 1, and the outer display 23 may display information about convenience for occupants of the vehicle 1. The information to be displayed on the inner display 22 and the outer display 23 can also be arbitrarily determined.

### Hardware Configuration of Vehicle

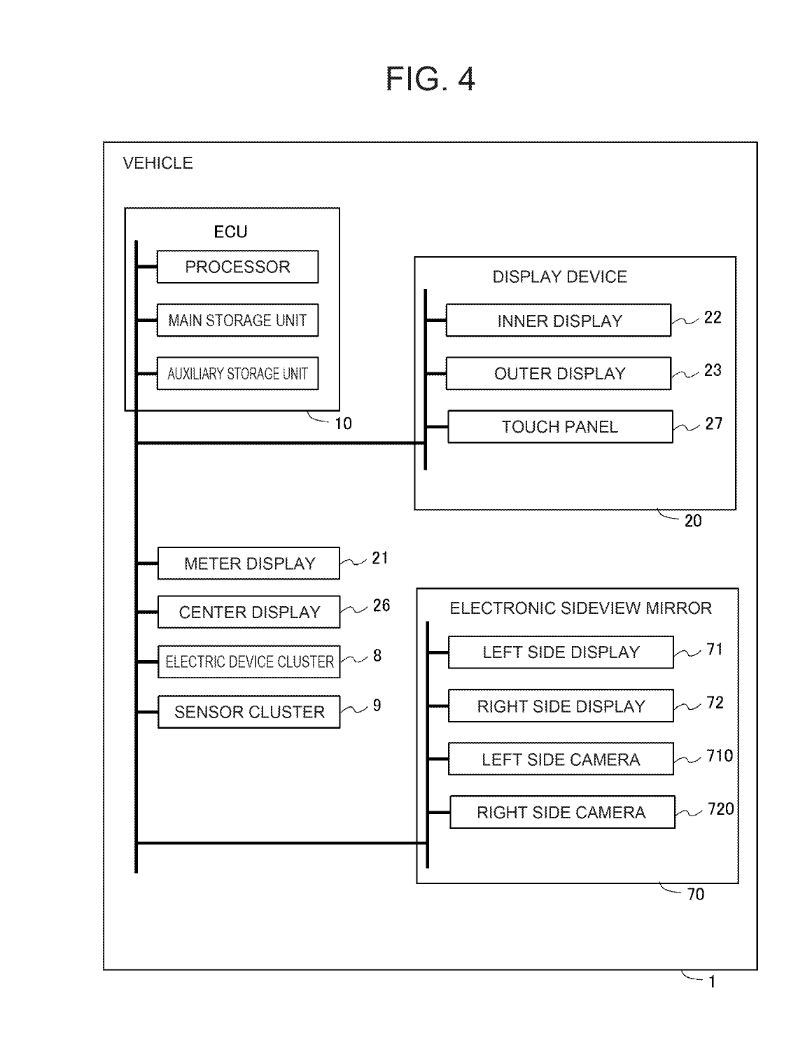

FIG. 4 is a view schematically showing one example of the hardware configuration of the vehicle 1 in the embodiment. The vehicle 1 in the embodiment has an ECU 10, the display device 20, the meter display 21, the center display 26, an electric device cluster 8, a sensor cluster 9, the electronic sideview mirror device 70, etc.

The ECU 10 can be configured as a computer having a processor (a CPU, a GPU, etc.), a main storage device (a RAM, a ROM, etc.), and an auxiliary storage device (an EPROM, a hard disc drive, a removable medium, etc.). The auxiliary storage device stores an operating system (OS), various programs, data used by the various programs, data of a guidance message to be described later, etc. As the processor executes a program in the auxiliary storage device, the ECU 10 realizes each function matching a predetermined purpose as will be described later. However, some or all of the functions may be realized as a hardware module by a hardware circuit, such as an application-specific integrated circuit (ASIC) or a field-programmable gate array (FPGA). The display device 20, the center display 26, the electric device cluster 8, the sensor cluster 9, the electronic sideview mirror device 70, etc., are connected to the ECU 10.

The display device 20 has the inner display 22, the outer display 23, and touch panels 27. The touch panels 27 are respectively disposed on the inner display 22 and the outer display 23. The touch panels 27 respectively detect a touch operation performed on the inner display 22 and the outer display 23.

The meter display 21 displays information required for travel of the vehicle, such as a speed of the vehicle (vehicle speed), an engine speed (when the vehicle 1 has an engine), a charge-discharge status (when the vehicle 1 has a driving battery), and a travel distance.

The center display 26 displays, for example, assistive information, such as car navigation, and contents about entertainment, such as audio contents or television programs.

The electric device cluster 8 is an aggregate of electric devices used in the vehicle 1. In one example, the electric device cluster 8 includes a fuel injection control valve, a spark plug, an actuator of a transmission, an actuator of an anti-lock brake system (ABS), an actuator of a power steering, an air conditioner, a suspension, an electrically powered seat, a navigation device, headlights, wipers, audio equipment, a telephone, a voice assistant, etc.

The sensor cluster 9 is an aggregate of a plurality of sensors for acquiring sensor data that is used in travel of the vehicle 1. The sensors may acquire physical amounts or may acquire image data etc. In one example, the sensor cluster 9 includes a vehicle speed sensor, an acceleration sensor, an accelerator position sensor, a brake sensor, a steering angle sensor, a crank position sensor, a coolant temperature sensor, an oil temperature sensor, an oil pressure sensor, an air flowmeter, a yaw rate sensor, a turn signal switch sensor, a shift position sensor, a seat position sensor, an inside air temperature sensor, an outside air temperature sensor, a sensor for the ADAS, etc.

The electronic sideview mirror device 70 is a device installed in the vehicle 1 in place of optical sideview mirrors (door mirrors, fender mirrors). The electronic sideview mirror device 70 in the embodiment has the left side display 71, the right side display 72, the left side camera 710, and the right side camera 720. The left side camera 710 photographs a left rear side of the vehicle 1. The left side display 71 displays an image photographed by the left side camera 710 (left sideview mirror image). The right side camera 720 photographs a right rear side of the vehicle 1. The right side display 72 displays an image photographed by the right side camera 720 (right sideview mirror image). In one example, photographing and displaying by the electronic sideview mirror device 70 start when a power source (e.g., an accessory power source) of the vehicle 1 is turned on and end when a predetermined time has elapsed since the power source of the vehicle 1 has been turned off.

### Software Configuration of ECU

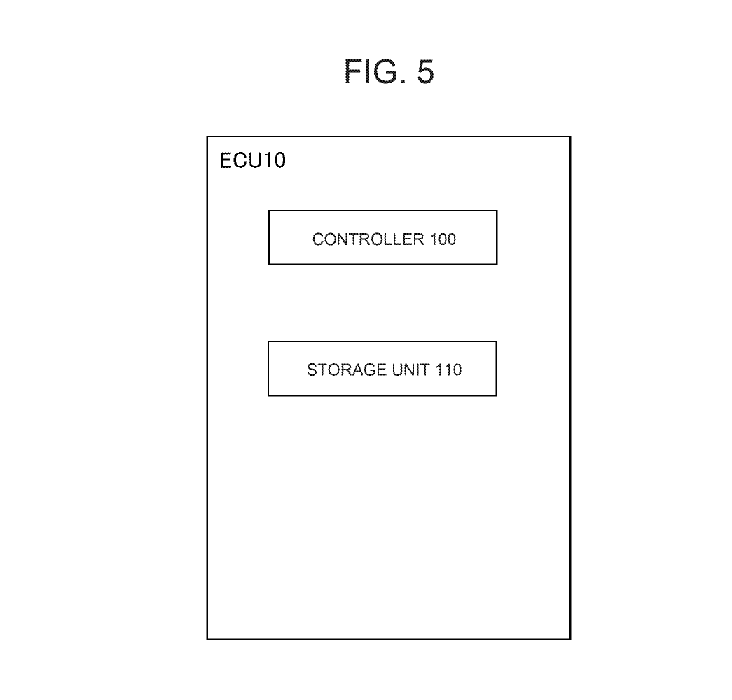

FIG. 5 is a block diagram showing one example of the software configuration of the ECU 10. The ECU 10 in the embodiment is configured to have a plurality of software modules including a controller 100 and a storage unit 110. These software modules are realized as the processor of the ECU 10 executes various programs stored in the auxiliary storage device. At least some of the functions of the controller 100 may be realized by a hardware circuit, such as an application-specific integrated circuit (ASIC) or a field-programmable gate array (FPGA). In the following description, information processing executed by the controller 100 is synonymous with information processing executed by the processor of the ECU 10. The storage unit 110 is means for storing information and configured to include a main storage unit and an auxiliary storage unit.

The controller 100 receives a touch signal from the touch panel 27, determines a user's input operation through the touch panel 27, and executes information processing according to the determined input operation. In the embodiment, the touch signal transmitted from the touch panel 27 to the controller 100 includes at least information showing a touch position (a position that the user's finger has touched) in the screen of the outer display 23.

Here, in a menu screen displayed on the outer display 23, when a GUI part for calling up a setting screen of the electronic sideview mirror device 70 has received a touch operation, the controller 100 identifies that the touch position is the display position of that GUI part according to the touch signal received from the touch panel 27. Information about the display positions of the GUI parts corresponding to the respective items included in the menu screen are stored in the storage unit 110 beforehand. According to the touch signal received from the touch panel 27 and the information in the storage unit 110, the controller 100 identifies that the touch position in the outer display 23 is the display position of the GUI part for calling up the setting screen of the electronic sideview mirror device 70. The controller 100 transmits a command for displaying the setting screen of the electronic sideview mirror device 70 on the outer display 23 to the display device 20.

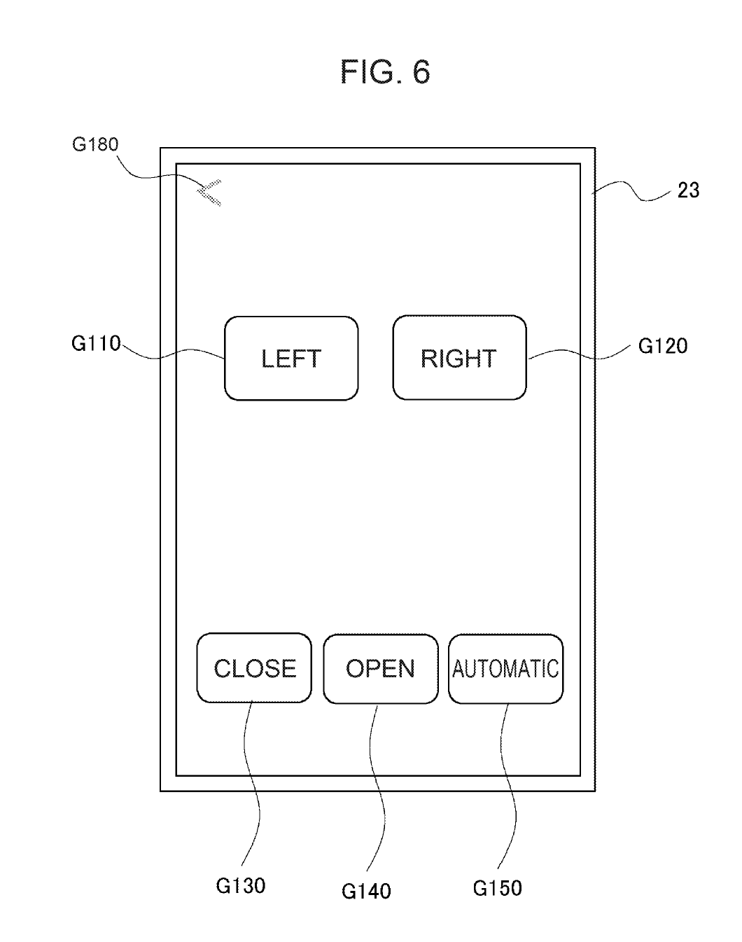

FIG. 6 is a view showing one example of the setting screen of the electronic sideview mirror device 70 displayed on the outer display 23. In the example shown in FIG. 6, the setting screen of the electronic sideview mirror device 70 includes a GUI part G110 for calling up an adjustment screen for the left sideview mirror image, a GUI part G120 for calling up an adjustment screen for the right sideview mirror image, a GUI part G130 for closing (folding) the side cameras 710, 720, a GUI part G140 for opening (deploying) the side cameras 710, 720, a GUI part G150 for automatically opening and closing (deploying and folding) the side cameras 710, 720, a GUI part G180 for returning to the menu screen, etc.

When one of the GUI parts G110 to G150, G180 has received a touch operation in a state where the setting screen illustrated in FIG. 6 is displayed on the outer display 23, a touch signal including information showing the touch position in the outer display 23 is transmitted from the touch panel 27 to the controller 100. According to the touch signal, the controller 100 determines which one of the display positions of the GUI parts G110 to G150, G180 has received the touch operation. In this case, it is assumed that information about the display positions of the GUI parts G110 to G150, G180 is stored in the storage unit 110 beforehand.

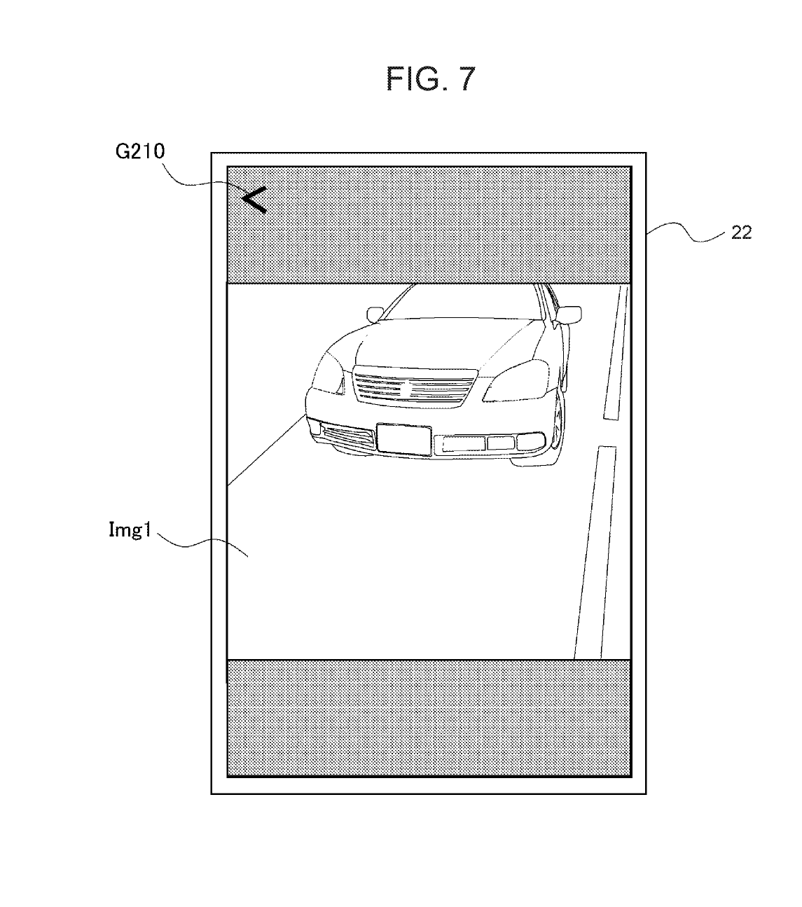

Here, when the touch position is determined to be the display position of the GUI part G110 for calling up the adjustment screen for the left sideview mirror image, the controller 100 transmits a command for displaying the adjustment screen for the left sideview mirror image on the inner display 22 to the display device 20. FIG. 7 is a view showing one example of the adjustment screen for the left sideview mirror image. In the embodiment, the adjustment screen for the left sideview mirror image includes an image Img1 (hereinafter may also be referred to as a "target image Img1") that is the same as the left sideview mirror image displayed on the left side display 71, and a GUI part G210 for returning to the setting screen of FIG. 6. Such an adjustment screen is generated by the controller 100 and transmitted to the display device 20. That is, the controller 100 acquires the left sideview mirror image from the electronic sideview mirror device 70 and generates this adjustment screen using the acquired left sideview mirror image. Generation of the adjustment screen and displaying of the adjustment screen are executed by real-time processing. That is, the target image Img1 displayed on the inner display 22 is updated in real time.

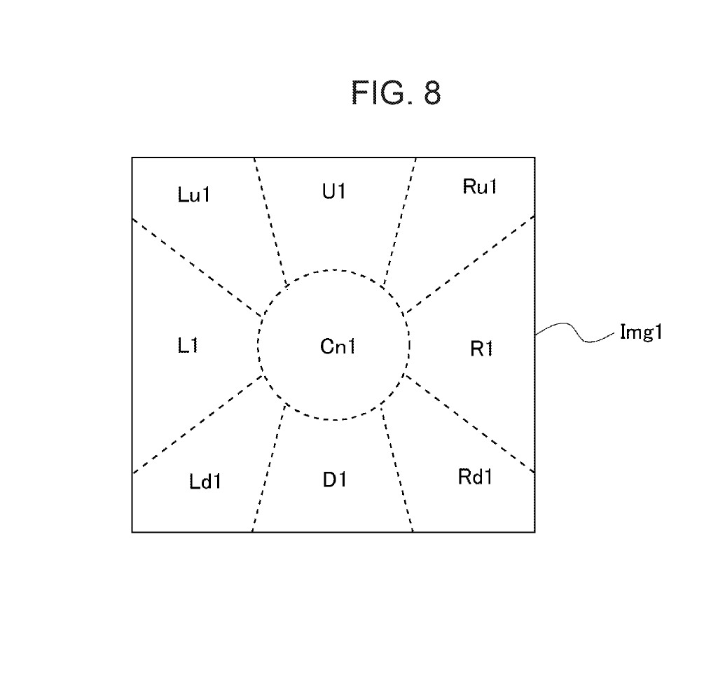

When the display region of the target image Img1 has received a touch operation (e.g., a tapping operation or a long-pressing operation) in a state where the adjustment screen as illustrated in FIG. 7 is displayed on the inner display 22, the controller 100 executes information processing for changing the photographing direction of the left sideview mirror image (the direction of the left side camera 710) according to the direction of the touch position (touch direction) with respect to a center in the display region of the target image Img1. In the embodiment, the display region of the target image Img1 is divided into a plurality of touch regions. FIG. 8 is a view showing one example of dividing the display region of the target image Img1 into a plurality of touch regions. In the example shown in FIG. 8, the display region of the target image Img1 is divided into nine touch regions: a center region Cn1, a right region R1 located in the rightward direction with respect to the center region Cn1, a left region L1 located in the leftward direction with respect to the center region Cn1, an upper region U1 located in the upward direction with respect to the center region Cn1, a lower region D1 located in the downward direction with respect to the center region Cn1, an obliquely right upper region Ru1 located in an obliquely rightward-upward direction with respect to the center region Cn1, an obliquely right lower region Rd1 located in an obliquely rightward-downward direction with respect to the center region Cn1, an obliquely left upper region Lu1 located in an obliquely leftward-upward direction with respect to the center region Cn1, and an obliquely left lower region Ld1 located in an obliquely leftward-downward direction with respect to the center region Cn1.

Here, when the right region R1 in the display region of the target image Img1 has received a touch operation, the controller 100 determines the touch direction to be the rightward direction. In this case, the controller 100 transmits, to the electronic sideview mirror device 70, a change command for changing the photographing direction of the left sideview mirror image to the rightward direction. The change command in the embodiment may include a change amount in addition to the direction in which the photographing direction of the left sideview mirror image is to be changed (in this case, the rightward direction). In one example, the change amount may be determined according to a touch time on the right region R1. That is, the controller 100 may determine the change amount in the photographing direction so as to have a larger value as the touch time on the right region R1 becomes longer. In that case, the touch panel 27 should transmit, to the controller 100, a touch signal including information showing the touch time in addition to the information showing the touch position.

When this change command is received by the electronic sideview mirror device 70, the direction of the left side camera 710 is changed by the change amount to the rightward direction. Thus, the photographing direction of the left sideview mirror image displayed on the left side display 71 and the inner display 22 is changed to the rightward direction by an amount according to the touch time.

When the left region L1 in the display region of the target image Img1 has received a touch operation, the controller 100 determines the touch direction to be the leftward direction. In this case, the controller 100 transmits, to the electronic sideview mirror device 70, a change command for changing the photographing direction of the left sideview mirror image to the leftward direction. The change command in this case may include the direction in which the photographing direction of the left sideview mirror image is to be changed (in this case, the leftward direction) and the change amount. When this change command is received by the electronic sideview mirror device 70, the direction of the left side camera 710 is changed to the leftward direction by the change amount. Thus, the photographing direction of the left sideview mirror image displayed on the left side display 71 and the inner display 22 is changed to the leftward direction by an amount according to the touch time.

When the upper region U1 in the display region of the target image Img1 has received a touch operation, the controller 100 determines the touch direction to be the upward direction. In this case, the controller 100 transmits, to the electronic sideview mirror device 70, a change command for changing the photographing direction of the left sideview mirror image to the upward direction. The change command in this case may include the direction in which the photographing direction of the left sideview mirror image is to be changed (in this case, the upward direction) and the change amount. When this change command is received by the electronic sideview mirror device 70, the direction of the left side camera 710 is changed to the upward direction by the change amount. Thus, the photographing direction of the left sideview mirror image displayed on the left side display 71 and the inner display 22 is changed to the upward direction by an amount according to the touch time.

When the lower region D1 in the display region of the target image Img1 has received a touch operation, the controller 100 determines the touch direction to be the downward direction. In this case, the controller 100 transmits, to the electronic sideview mirror device 70, a change command for changing the photographing direction of the left sideview mirror image to the downward direction. The change command in this case may include the direction in which the photographing direction of the left sideview mirror image is to be changed (in this case, the downward direction) and the change amount. When this change command is received by the electronic sideview mirror device 70, the direction of the left side camera 710 is changed to the downward direction by the change amount. Thus, the photographing direction of the left sideview mirror image displayed on the left side display 71 and the inner display 22 is changed to the downward direction by an amount according to the touch time.

When the obliquely right upper region Ru1 in the display region of the target image Img1 has received a touch operation, the controller 100 determines the touch direction to be the obliquely rightward-upward direction. In this case, the controller 100 transmits, to the electronic sideview mirror device 70, a change command for changing the photographing direction of the left sideview mirror image to the obliquely rightward-upward direction. The change command in this case may include the direction in which the photographing direction of the left sideview mirror image is to be changed (in this case, the obliquely rightward-upward direction) and the change amount. When this change command is received by the electronic sideview mirror device 70, the direction of the left side camera 710 is changed to the obliquely rightward-upward direction by the change amount. Thus, the photographing direction of the left sideview mirror image displayed on the left side display 71 and the inner display 22 is changed to the obliquely rightward-upward direction by an amount according to the touch time.

When the obliquely right lower region Rd1 in the display region of the target image Img1 has received a touch operation, the controller 100 determines the touch direction to be the obliquely rightward-downward direction. In this case, the controller 100 transmits, to the electronic sideview mirror device 70, a change command for changing the photographing direction of the left sideview mirror image to the obliquely rightward-downward direction. The change command in this case may include the direction in which the photographing direction of the left sideview mirror image is to be changed (in this case, the obliquely rightward-downward direction) and the change amount. When this change command is received by the electronic sideview mirror device 70, the direction of the left side camera 710 is changed to the obliquely rightward-downward direction by the change amount. Thus, the photographing direction of the left sideview mirror image displayed on the left side display 71 and the inner display 22 is changed to the obliquely rightward-downward direction by an amount according to the touch time.

When the obliquely left upper region Lu1 in the display region of the target image Img1 has received a touch operation, the controller 100 determines the touch direction to be the obliquely leftward-upward direction. In this case, the controller 100 transmits, to the electronic sideview mirror device 70, a change command for changing the photographing direction of the left sideview mirror image to the obliquely leftward-upward direction. The change command in this case may include the direction in which the photographing direction of the left sideview mirror image is to be changed (in this case, the obliquely leftward-upward direction) and the change amount. When this change command is received by the electronic sideview mirror device 70, the direction of the left side camera 710 is changed to the obliquely leftward-upward direction by the change amount. Thus, the photographing direction of the left sideview mirror image displayed on the left side display 71 and the inner display 22 is changed to the obliquely leftward-upward direction by an amount according to the touch time.

When the obliquely left lower region Ld1 in the display region of the target image Img1 has received a touch operation, the controller 100 determines the touch direction to be the obliquely leftward-downward direction. In this case, the controller 100 transmits, to the electronic sideview mirror device 70, a change command for changing the photographing direction of the left sideview mirror image to the obliquely leftward-downward direction. The change command in this case may include the direction in which the photographing direction of the left sideview mirror image is to be changed (in this case, the obliquely leftward-downward direction) and the change amount. When this change command is received by the electronic sideview mirror device 70, the direction of the left side camera 710 is changed to the obliquely leftward-downward direction by the change amount. Thus, the photographing direction of the left sideview mirror image displayed on the left side display 71 and the inner display 22 is changed to the obliquely leftward-downward direction by an amount according to the touch time.

When the center region Cn1 in the display region of the target image Img1 has received a touch operation, the controller 100 does not execute the information processing for changing the photographing direction of the left sideview mirror image (the direction of the left side camera 710).

When the display position of the GUI part G120 for calling up the adjustment screen for the right sideview mirror image is touched in a state where the setting screen illustrated in FIG. 6 is displayed on the outer display 23, the controller 100 transmits, to the display device 20, a command for displaying the adjustment screen for the right sideview mirror image on the outer display 23. The configuration of the adjustment screen for the right sideview mirror image displayed on the outer display 23 may be the same as the configuration of the adjustment screen for the left sideview mirror image. That is, the controller 100 should receive the right sideview mirror image from the electronic sideview mirror device 70, and generate this adjustment screen using the received right sideview mirror image. Generation of the adjustment screen and displaying of the adjustment screen should be executed by real-time processing as with the left sideview mirror image. Then, the photographing direction of the right sideview mirror image (the direction of the right side camera 720) should be changed according to the touch position and the touch time of the display region (the region corresponding to the target image Img1 in FIG. 7) of the right sideview mirror image on the outer display 23.

The method of dividing the touch region is not restricted to the example shown in FIG. 8 and may be changed as appropriate according to the form of implementation.

### Behavior of ECU

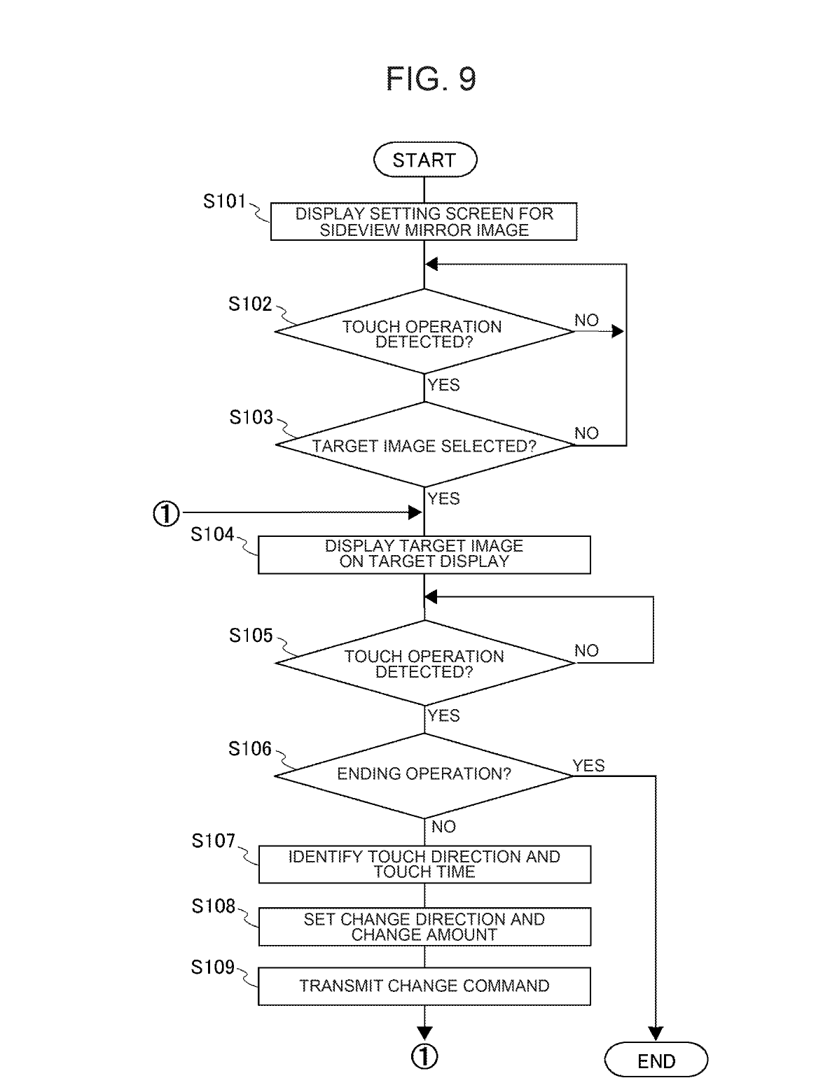

FIG. 9 is a flowchart showing one example of a processing routine that is executed in the ECU 10 in the embodiment. The processing routine illustrated in FIG. 9 is a routine that is executed when, as a trigger, the GUI part for calling up the setting screen of the electronic sideview mirror device 70 receives a touch operation in the menu screen displayed on the outer display 23. While the main executer of the routine of FIG. 9 is the ECU 10, description will be given here with the main executor being the controller 100 that is a software module of the ECU 10.

In the processing routine of FIG. 9, in response to an operation for calling up the setting screen of the electronic sideview mirror device 70 having been performed, the controller 100 transmits, to the display device 20, a command for displaying the setting screen of the electronic sideview mirror device 70 on the outer display 23 (step S101). Having received this command, the display device 20 displays the setting screen as illustrated in FIG. 6 on the outer display 23. When the controller 100 ends the execution of the process of step S101, the controller 100 executes the process of step S102.

In step S102, the controller 100 determines whether a touch operation has been detected in the setting screen of the electronic sideview mirror device 70. Specifically, the controller 100 determines whether a touch signal from the touch panel 27 has been received. When the controller 100 has not received a touch signal from the touch panel 27 (the determination in step S102 is in the negative), the controller 100 stands by until receiving a touch signal from the touch panel 27. On the other hand, when the controller 100 has received a touch signal from the touch panel 27 (determination in step S102 is in the affirmative), the controller 100 executes the process of step S103.

In step S103, the controller 100 determines whether either the left sideview mirror image or the right sideview mirror image has been selected as the target image. Specifically, according to the touch signal received from the touch panel 27, the controller 100 determines whether either the GUI part for calling up the adjustment screen for the left sideview mirror image (G110 in FIG. 6) or the GUI part for calling up the adjustment screen for the right sideview mirror image (G120 in FIG. 6) has received a touch operation. That is, the controller 100 determines whether the touch position included in the touch signal coincides with the display position of either the GUI part G110 or the GUI part G120. When the touch position included in the touch signal coincides with neither of the GUI part G110 nor the GUI part G120 (determination in step S103 is in the negative), the controller 100 executes the process of step S102 again. However, when the touch position included in the touch signal coincides with the display position of the GUI part for returning to the menu screen (G180 in FIG. 6), the controller 100 ends the execution of the processing routine of FIG. 9. When the touch position included in the touch signal coincides with the display position of either the GUI part G110 or the GUI part G120 (determination in step S103 is in the affirmative), the controller 100 executes the process of step S104. When the touch position coincides with the display position of the GUI part G110, this means that the left sideview mirror image has been selected as the target image. On the other hand, when the touch position coincides with the display position of the GUI part G120, this means that the right sideview mirror image has been selected as the target image.

In step S104, the controller 100 displays the target image that is one of the left sideview mirror image and the right sideview mirror image on the target display that is one of the inner display 22 and the outer display 23. In this case, when the target image is the left sideview mirror image, the controller 100 displays the target image on the inner display 22. Specifically, the controller 100 first acquires the real-time left sideview mirror image photographed by the left side camera 710 from the electronic sideview mirror device 70. Subsequently, the controller 100 generates the adjustment screen for the left sideview mirror image using the acquired left sideview mirror image (target image Img1). Then, the controller 100 transmits, to the display device 20, a command for displaying the generated adjustment screen on the inner display 22 (corresponding to the target display). Thus, the adjustment screen (the screen illustrated in FIG. 7) including the left sideview mirror image is displayed on the inner display 22. In this case, the display region of the target image Img1 (left sideview mirror image) is divided into a plurality of touch regions as illustrated in FIG. 8.

When the target image is the right sideview mirror image, the controller 100 displays the target image on the outer display 23. Specifically, the controller 100 first acquires the real-time right sideview mirror image photographed by the right side camera 720 from the electronic sideview mirror device 70. Subsequently, the controller 100 generates the adjustment screen for the right sideview mirror image using the acquired right sideview mirror image (target image Img1). Then, the controller 100 transmits, to the display device 20, a command for displaying the generated adjustment screen on the outer display 23 (corresponding to the target display). Thus, the adjustment screen including the right sideview mirror image is displayed on the outer display 23. In this case, the display region of the target image Img1 (right sideview mirror image) is divided into a plurality of touch regions as with the adjustment screen for the left sideview mirror image.

When the controller 100 ends the execution of the process of step S104 by the above-described procedure, the controller 100 executes the process of step S105. In step S105, the controller 100 determines whether a touch operation has been detected in the adjustment screen for the target image Img1. Specifically, the controller 100 determines whether a touch signal from the touch panel 27 has been received. When the controller 100 has not received a touch signal from the touch panel 27 (determination in step S105 is in the negative), the controller 100 stands by until receiving a touch signal from the touch panel 27. On the other hand, when the controller 100 has received a touch signal from the touch panel 27 (determination in step S105 is in the affirmative), the controller 100 executes the process of step S106.

In step S106, according to the touch signal received from the touch panel 27, the controller 100 determines whether the touch operation detected in step S105 is an operation for ending the adjustment of the target image Img1. Specifically, the controller 100 determines whether the touch position included in the touch signal coincides with the display position of the GUI part (e.g., G210 in FIG. 7) for returning to the setting screen illustrated in FIG. 6 (the setting screen of the electronic sideview mirror device 70). When the touch position coincides with the display position of the GUI part for returning to the setting screen of FIG. 6 (determination in step S106 is in the affirmative), the controller 100 ends the execution of the processing routine of FIG. 9. On the other hand, when the touch position does not coincide with the display position of the GUI part for returning to the setting screen of FIG. 6 (determination in step S106 is in the negative), the controller 100 executes the process of step S107.

In step S107, according to the touch signal received from the touch panel 27, the controller 100 determines the touch direction. Specifically, the controller 100 determines the touch direction according to the touch region that has received the touch operation in the display region of the target image Img1. In one example, the controller 100 determines the touch direction according to which one of the touch regions illustrated in FIG. 8 the touch position included in the touch signal belongs to. The touch direction in this case is determined as follows:

(1) When the touch position is the right region R1, the touch direction is determined to be the rightward direction.

(2) When the touch position is the left region L1, the touch direction is determined to be the leftward direction.

(3) When the touch position is the upper region U1, the touch direction is determined to be the upward direction.

(4) When the touch position is the lower region D1, the touch direction is determined to be the downward direction.

(5) When the touch position is the obliquely right upper region Ru1, the touch direction is determined to be the obliquely rightward-upward direction.

(6) When the touch position is the obliquely right lower region Rd1, the touch direction is determined to be the obliquely rightward-downward direction.

(7) When the touch position is the obliquely left upper region Lu1, the touch direction is determined to be the obliquely leftward-upward direction.

(8) When the touch position is the obliquely left lower region Ld1, the touch direction is determined to be the obliquely leftward-downward direction.

When the controller 100 ends the execution of the process of step S107, the controller 100 executes the process of step S108.

In step S108, according to the touch direction identified in step S107 and the touch time included in the touch signal, the controller 100 sets the direction in which the photographing direction of the target image Img1 is to be changed (change direction) and the change amount. The change direction in this case is set as follows:

(10) When the touch direction is the rightward direction, the change direction is set to the rightward direction.

(20) When the touch direction is the leftward direction, the change direction is set to the leftward direction.

(30) When the touch direction is the upward direction, the change direction is set to the upward direction.

(40) When the touch direction is the downward direction, the change direction is set to the downward direction.

(50) When the touch direction is the obliquely rightward-upward direction, the change direction is set to the obliquely rightward-upward direction.

(60) When the touch direction is the obliquely rightward-downward direction, the change direction is set to the obliquely rightward-downward direction.

(70) When the touch direction is the obliquely leftward-upward direction, the change direction is set to the obliquely leftward-upward direction.

(80) When the touch direction is the obliquely leftward-downward direction, the change direction is set to the obliquely leftward-downward direction.

The controller 100 sets the change amount in the change direction so as to become larger as the touch time included in the touch signal becomes longer. The correlation between the touch time and the change amount may be stored in the storage unit 110 beforehand in the form of a map, a function expression, etc.

When the controller 100 ends the execution of the process of step S108, the controller 100 executes the process of step S109. In step S109, the controller 100 transmits, to the electronic sideview mirror device 70, a change command signal including the change direction and the change amount set in step S108. In the electronic sideview mirror device 70 having received this change command signal, the direction of the side camera 710 or 720 that is photographing the target image Img1 is changed according to the change direction and the change amount included in the change command signal. That is, the direction of the side camera 710 or 720 that is photographing the target image Img1 is changed by the change amount to the change direction.

When the controller 100 ends the execution of the process of step S109, the controller 100 executes the processes of step S104 and the subsequent steps again. When the touch region identified in step S107 is the center region Cn1 among the regions illustrated in FIG. 8, or when the touch region identified in step S107 is outside the display region of the target image Img1 (e.g., in the display region colored in gray in FIG. 7), the controller 100 may skip the processes of steps S108 and S109 and execute the processes of step S104 and the subsequent steps.

### Workings and Advantages of Embodiment

In the vehicle 1 of the embodiment, when the driver performs an operation of calling up the adjustment screen for the left sideview mirror image (e.g., an operation of touching the GUI part G110 in the setting screen illustrated in FIG. 6), the adjustment screen for the left sideview mirror image is displayed on the inner display 22. The adjustment screen displayed on the inner display 22 displays the left sideview mirror image (e.g., see FIG. 7). In this case, the display region of the left sideview mirror image is divided into a plurality of touch regions, and when a region other than the center region (e.g., Cn1 in FIG. 8) of these touch regions (e.g., R1, L1, U1, D1, Ru1, Rd1, Lu1, or Ld1 in FIG. 8) receives the user's touch operation, the direction (photographing direction) of the left side camera 710 is changed to the direction corresponding to the touch region that has received the touch operation (touch direction). The change amount in this case is set so as to become larger as the touch time on the touch region becomes longer.

In the vehicle 1 of the embodiment, when the driver performs an operation of calling up the adjustment screen for the right sideview mirror image (e.g., an operation of touching the GUI part G120 in the setting screen illustrated in FIG. 6), the adjustment screen for the right sideview mirror image is displayed on the outer display 23. The adjustment screen displayed on the outer display 23 displays the right sideview mirror image. In this case, the display region of the right sideview mirror image is divided into a plurality of touch regions, and when a region other than the center region of these touch regions receives the user's touch operation, the direction (photographing direction) of the right side camera 720 is changed to the direction corresponding to the touch region that has received the touch operation (touch direction). The change amount in this case is set so as to become larger as the touch time on the touch region becomes longer.

Thus, the embodiment allows the driver to intuitively adjust the photographing direction of the target image that is one of the left sideview mirror image and the right sideview mirror image by performing a touch operation on the target display that is one of the inner display 22 and the outer display 23, in a state of being seated in the driver seat 2. Since the inner display 22 and the outer display 23 are disposed near the steering wheel 4, the driver can adjust the photographing direction while checking the target image displayed on the target display from up close. This makes it also easy for the driver to finely adjust the photographing direction of the target image. As a result, the operability of the electronic sideview mirror device 70 can be improved.

### Modified Example 1

In the above-described embodiment, the example has been described in which the display region of the target image in the adjustment screen for the target image is divided into a plurality of touch regions and the change direction is set according to the touch region that has received the user's touch operation. On the other hand, GUI parts for selecting the change direction may be displayed in the display region of the target image and the change direction may be set according to the selected GUI part.

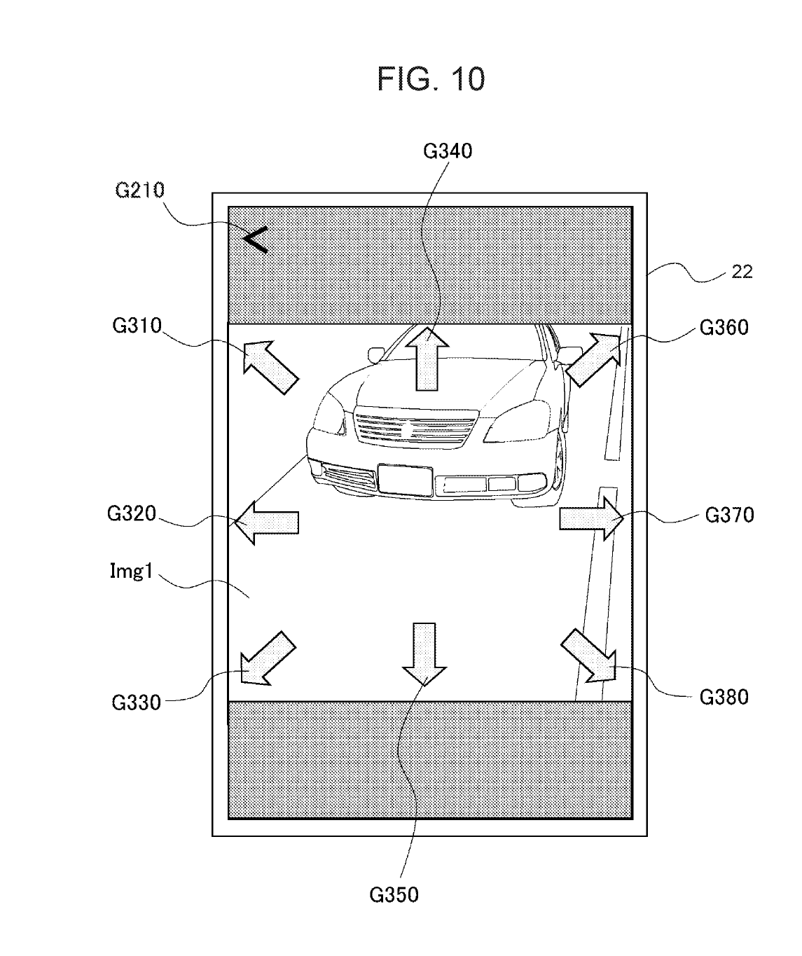

FIG. 10 is a view showing one example of the adjustment screen for the left sideview mirror image displayed on the inner display 22. In this modified example, the adjustment screen for the left sideview mirror image includes the target image Img1 and the GUI part G210 for returning to the setting screen of FIG. 6. Further, in the display region of the target image Img1, a plurality of GUI parts G310 to G380 for selecting the change direction of the photographing direction is displayed as superimposed. The functions of the respective GUI parts G310 to G380 in FIG. 10 are as follows:

(a) G310: specifies the obliquely leftward-upward direction as the change direction

(b) G320: specifies the leftward direction as the change direction

(c) G330: specifies the obliquely leftward-downward direction as the change direction

(d) G340: specifies the upward direction as the change direction

(e) G350: specifies the downward direction as the change direction

(f) G360: specifies the obliquely rightward-upward direction as the change direction

(g) G370: specifies the rightward direction as the change direction

(h) G380: specifies the obliquely rightward-downward direction as the change direction

When one of the GUI parts G310 to G380 has received a touch operation (e.g., a tapping operation or a long-pressing operation) in a state where the adjustment screen as illustrated in FIG. 10 is displayed on the outer display 23, the controller 100 sets the change direction according to the one of the GUI parts G310 to G380 that has received the touch operation. Further, the controller 100 sets the change amount according to the touch time of that one of the GUI parts G310 to G380. The controller 100 transmits a change command signal including the set change direction and change amount to the electronic sideview mirror device 70.

The configuration of the adjustment screen for the right sideview mirror image displayed on the outer display 23 may be the same as the configuration of the adjustment screen for the left sideview mirror image. That is, the adjustment screen for the right sideview mirror image may include the target image Img1 and the GUI part for returning to the setting screen of FIG. 6. Further, in the display region of the target image Img1, a plurality of GUI parts for selecting the change direction may be displayed as superimposed. When one of the GUI parts has received a touch operation, the change direction should be set according to the GUI part that has received the touch operation, and the change amount should be set according to the touch time of that GUI part. Further, the controller 100 should transmit a change command signal including the set change direction and change amount to the electronic sideview mirror device 70.

### Behavior of ECU

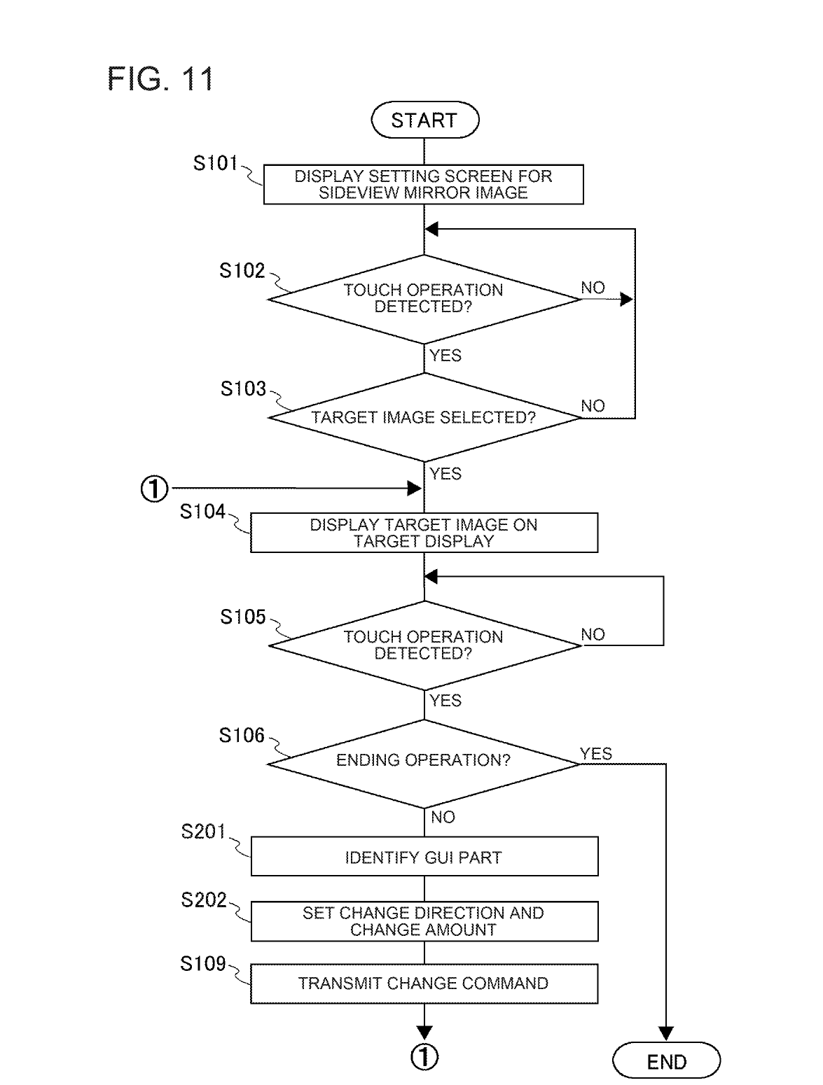

FIG. 11 is a flowchart showing one example of a processing routine that is executed in the ECU 10 of Modified Example 1. Like the processing routine illustrated in FIG. 9, the processing routine illustrated in FIG. 11 is executed when, as a trigger, the GUI part for calling up the setting screen of the electronic sideview mirror device 70 receives a touch operation in the menu screen displayed on the outer display 23. Those processes in FIG. 11 that are the same as in FIG. 9 are denoted by the same reference signs as in FIG. 9, and description thereof will be omitted.

In the processing routine of FIG. 11, when the determination in step S106 is in the negative, the controller 100 executes the process of step S201. In step S201, according to the touch signal received from the touch panel 27, the controller 100 identifies one of the GUI parts G310 to G380 that has received the touch operation in the display region of the target image Img1. Specifically, the controller 100 determines to which one of the GUI parts G310 to G380 illustrated in FIG. 10 the touch position included in the touch signal corresponds. When the controller 100 ends the execution of the process of step S201, the controller 100 executes the process of step S202.

In step S202, according to the one of the GUI parts G310 to G380 that has been identified in step S201 and the touch time included in the touch signal, the controller 100 sets the direction in which the photographing direction of the target image Img1 is to be changed (change direction) and the change amount. In this case, the controller 100 should set the change direction according to the functions (a) to (h) described above. When the controller 100 ends the execution of the process of step S202, the controller 100 executes the process of step S109.

Modified Example 1 can produce workings and advantages similar to those of the above-described embodiment.

### Modified Example 2

In the above-described embodiment, the example has been described in which the display region of the target image in the adjustment screen for the target image is divided into a plurality of touch regions and the change direction is set according to the touch region that has received the user's touch operation. On the other hand, the change direction and the change amount may be set according to a sliding direction and a sliding amount of the user's swiping operation on the adjustment screen for the target image.

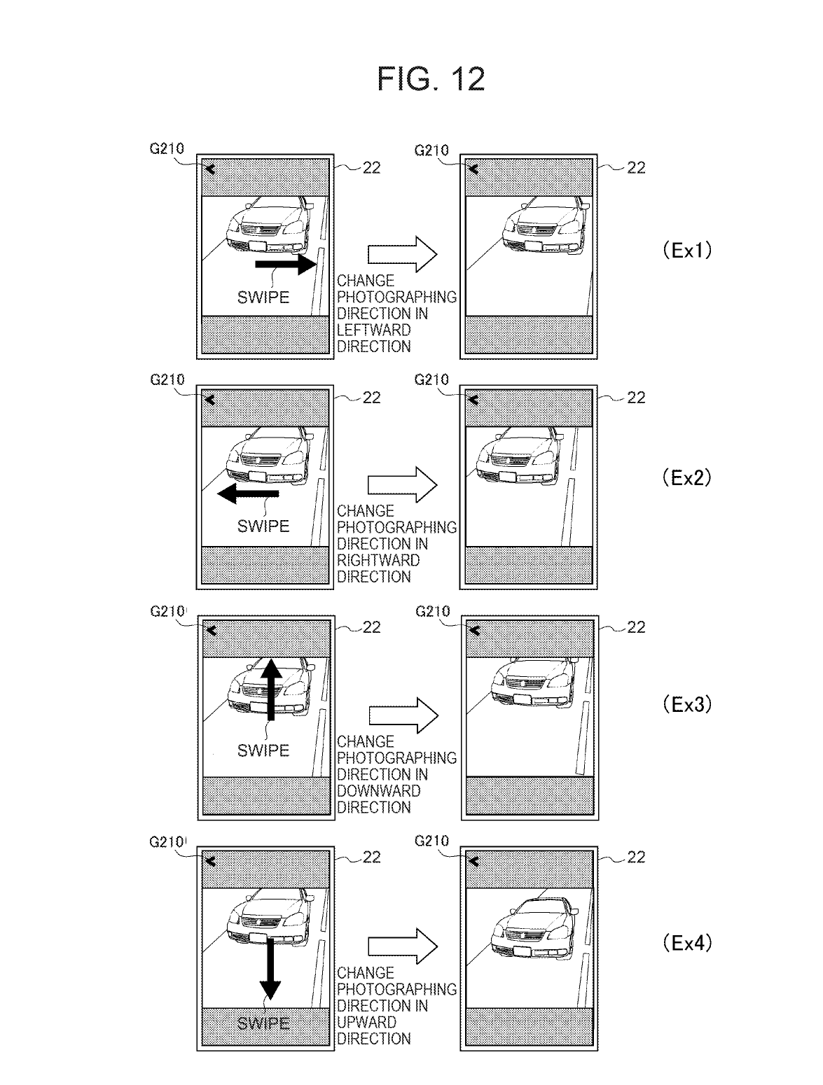

FIG. 12 is a view showing an example in which the photographing direction of the target image is changed according to a swiping operation performed on the adjustment screen for the target image. FIG. 12 shows an example of changing the photographing direction of the left sideview mirror image according to a swiping operation performed on the adjustment screen for the left sideview mirror image displayed on the inner display 22.

As shown in (Ex1) in FIG. 12, when the user performs a rightward swiping operation on the adjustment screen for the left sideview mirror image displayed on the inner display 22, the controller 100 sets the change direction to the leftward direction that is opposite from the sliding direction of the swiping operation, and sets the change amount according to the sliding amount of the swiping operation.

As shown in (Ex2) in FIG. 12, when the user performs a leftward swiping operation on the adjustment screen for the left sideview mirror image displayed on the inner display 22, the controller 100 sets the change direction to the rightward direction that is opposite from the sliding direction of the swiping operation, and sets the change amount according to the sliding amount of the swiping operation.

As shown in (Ex3) in FIG. 12, when the user performs an upward swiping operation on the adjustment screen for the left sideview mirror image displayed on the inner display 22, the controller 100 sets the change direction to the downward direction that is opposite from the sliding direction of the swiping operation, and sets the change amount according to the sliding amount of the swiping operation.

As shown in (Ex4) in FIG. 12, when the user performs a downward swiping operation on the adjustment screen for the left sideview mirror image displayed on the inner display 22, the controller 100 sets the change direction to the upward direction that is opposite from the sliding direction of the swiping operation, and sets the change amount according to the sliding amount of the swiping operation.

While this is not illustrated in FIG. 12, when the user has performed an obliquely rightward-upward (or obliquely rightward-downward) swiping operation, the controller 100 may set the change direction to the obliquely leftward-downward direction (or the obliquely leftward-upward direction) that is opposite from the sliding direction of the swiping operation, and set the change amount according to the sliding amount of the swiping operation.

To set the change direction and the change amount as described above, in Modified Example 2, the touch signal transmitted from the touch panel 27 to the controller 100 includes information showing a start position and an end position of the swiping operation. Having received such a touch signal, the controller 100 determines the sliding direction and the sliding amount based on the start position and the end position included in the touch signal.

The adjustment method of the right sideview mirror image may be the same as that of the left sideview mirror image. That is, the change direction and the change amount of the right sideview mirror image should be set according to a swiping operation performed on the adjustment screen for the right sideview mirror image displayed on the outer display 23.

### Behavior of ECU

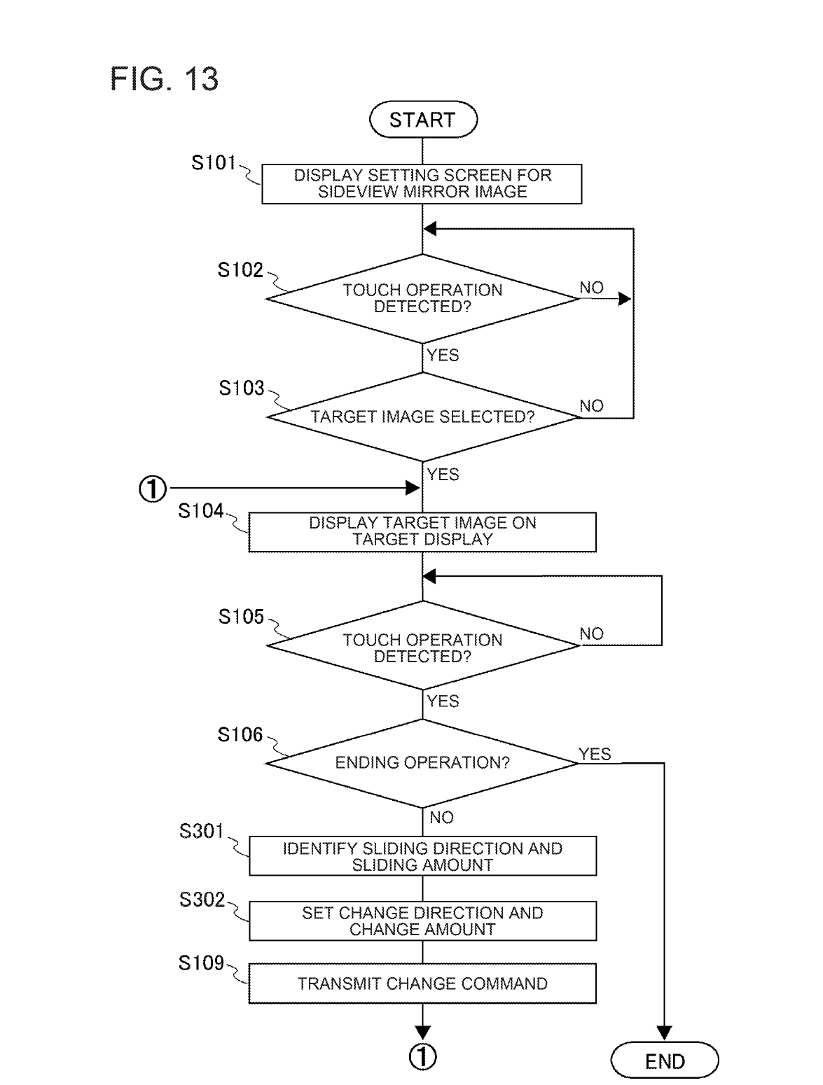

FIG. 13 is a flowchart showing one example of a processing routine that is executed in the ECU 10 in Modified Example 2. Like the processing routine illustrated in FIG. 9, the processing routine illustrated in FIG. 13 is executed when, as a trigger, the GUI part for calling up the setting screen of the electronic sideview mirror device 70 has received a touch operation in the menu screen displayed on the outer display 23. In FIG. 13, those processes that are the same as in FIG. 9 are denoted by the same reference signs as in FIG. 9, and description thereof will be omitted.

In the processing routine of FIG. 13, when the determination in step S106 is in the negative, the controller 100 executes the process of step S301. In step S301, according to the touch signal received from the touch panel 27, the controller 100 determines the sliding direction and the sliding amount of the swiping operation performed on the adjustment screen for the target image Img1. Specifically, according to the start position and the end position of the swiping operation included in the touch signal, the controller 100 identifies the sliding direction and the sliding amount of the swiping operation. In one example, the controller 100 may identify the sliding direction according to the direction of a vector oriented from the start position to the end position, and identify the sliding amount according to the magnitude of that vector (the distance from the start position to the end position). When the controller 100 ends the execution of the process of step S301, the controller 100 executes the process of step S302.

In step S302, according to the sliding direction and the sliding amount identified in step S301, the controller 100 sets the direction in which the photographing direction of the target image Img1 is to be changed (change direction) and the change amount. In this case, as illustrated in FIG. 12, the controller 100 sets the opposite direction from the sliding direction as the change direction, and sets the change amount so as to have a larger value as the sliding amount becomes larger. When the controller 100 ends the execution of the process of step S302, the controller 100 executes the process of step S109.

Modified Example 2 can produce workings and advantages similar to those of the above-described embodiment.

### Modified Example 3

In the above-described embodiment, the example of changing the photographing direction of the target image has been described. On the other hand, the angle of view of the target image may also be changed in addition to the photographing direction of the target image.

In this modified example, when a pinching operation is performed on the adjustment screen for the target image, the angle of view of the target image (the angle of view of the side camera 710 or 720 that is photographing the target image) is changed according to the operation amount of the pinching operation.

Here, when a pinching operation is performed on the adjustment screen for the target image, a touch signal including touch positions respectively of the two fingers when the pinching operation has started and touch positions respectively of the two fingers when the pinching operation has ended is transmitted from the touch panel 27 to the controller 100. Having received such a touch signal, the controller 100 calculates, according to the touch signal, the relative distance between the two fingers when the pinching operation has started and the relative distance between the two fingers when the pinching operation has ended. Next, the controller 100 subtracts the relative distance between the two fingers when the pinching operation has started from the relative distance between the two fingers when the pinching operation has ended to obtain a difference between the relative distances between the two fingers (hereinafter may also be referred to as a "difference in distance").

When the difference in distance calculated as described above is a positive value, the pinching operation having been performed on the adjustment screen for the target image can be regarded as a pinching-out operation. Therefore, the controller 100 transmits, to the electronic sideview mirror device 70, a change command for reducing the angle of view of the target image (scaling up the target image). The change command in this case may include a reduction ratio (< 100%) of the angle of view. In one example, the reduction ratio of the angle of view included in the change command may be set so as to have a smaller value as the absolute value of the difference in distance becomes larger.

When the difference in distance calculated as described above is a negative value, the pinching operation having been performed on the adjustment screen for the target image can be regarded as a pinching-in operation. Therefore, the controller 100 transmits, to the electronic sideview mirror device 70, a change command for increasing the angle of view of the target image (scaling down the target image). The change command in this case may include an increase ratio (> 100%) of the angle of view. In one example, the increase ratio of the angle of view included in the change command may be set so as to have a larger value as the absolute value of the difference in distance becomes larger.

When the above-described change command is received by the electronic sideview mirror device 70, the angle of view of the side camera 710 or 720 that is photographing the target image is increased or reduced according to the increase ratio or the reduction ratio included in the change command.

### Behavior of ECU

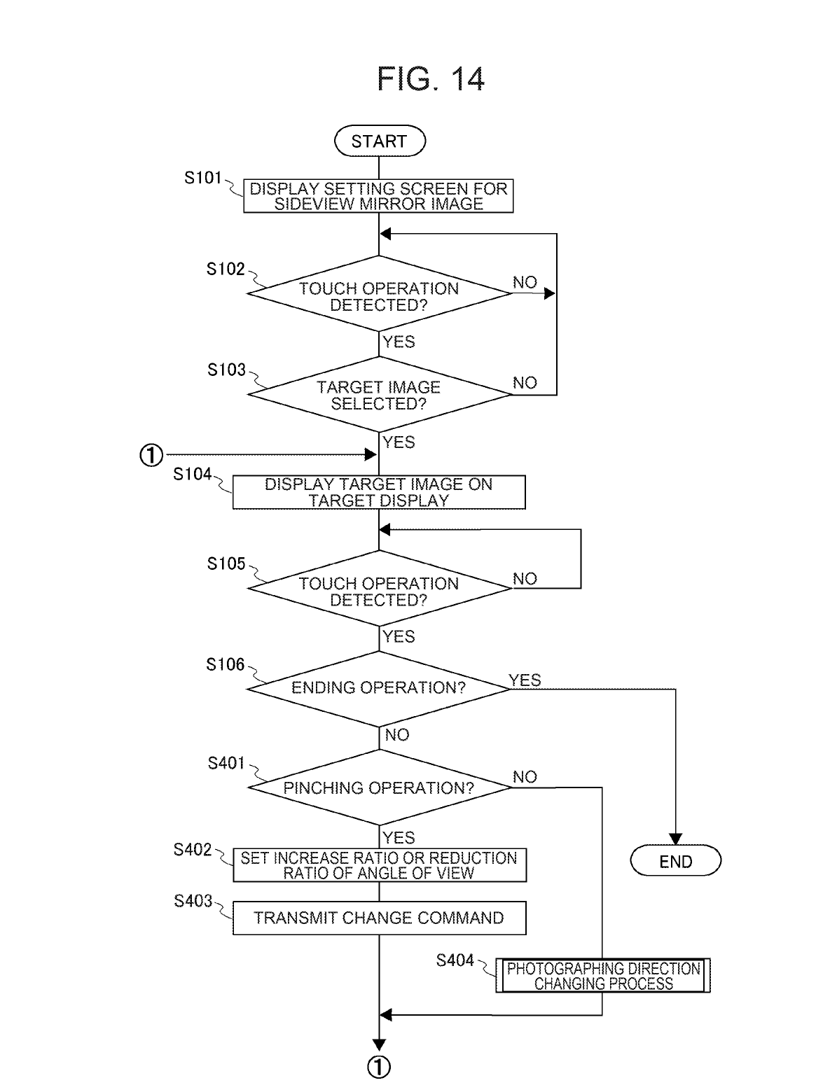

FIG. 14 is a flowchart showing one example of a processing routine that is executed in the ECU 10 in Modified Example 3. Like the processing routine illustrated in FIG. 9, the processing routine illustrated in FIG. 14 is executed when, as a trigger, the GUI part for calling up the setting screen of the electronic sideview mirror device 70 has received a touch operation in the menu screen displayed on the outer display 23. In FIG. 14, those processes that are the same as in FIG. 9 are denoted by the same reference signs as in FIG. 9, and description thereof will be omitted.

In the processing routine of FIG. 14, when the determination in step S106 is in the negative, the controller 100 executes the process of step S401. In step S401, according to the touch signal received from the touch panel 27, the controller 100 determines whether the touch operation performed on the adjustment screen for the target image Img1 is a pinching operation. In one example, when the touch start positions and the touch end positions of two fingers are included in the touch signal, the controller 100 may determine that the touch operation performed on the adjustment screen for the target image Img1 is a pinching operation (determination in step S401 is in the affirmative). When a touch position of one finger and a touch time are included in the touch signal, the controller 100 may determine that the touch operation performed on the adjustment screen for the target image Img1 is not a pinching operation (determination in step S401 is in the negative).

When the determination in step S401 is in the affirmative, the controller 100 executes the process of step S402. In step S402, the controller 100 sets the increase ratio or the reduction ratio of the angle of view according to the touch signal received from the touch panel 27. Specifically, the controller 100 calculates the relative distance between the two fingers when the pinching operation has started and the relative distance between the two fingers when the pinching operation has ended. Subsequently, the controller 100 subtracts the relative distance between the two fingers when the pinching operation has started from the relative distance between the two fingers when the pinching operation has ended to calculate the difference in distance. When the calculated difference in distance is a positive value (when the pinching operation is a pinching-out operation), the controller 100 sets the reduction ratio of the angle of view according to the absolute value of the difference in distance. That is, the controller 100 sets the reduction ratio of the angle of view so as to have a smaller value as the absolute value of the difference in distance becomes larger. When the calculated difference in distance is a negative value (when the pinching operation is a pinching-in operation), the controller 100 sets the increase ratio of the angle of view according to the absolute value of the difference in distance. That is, the controller 100 sets the increase ratio of the angle of view so as to have a larger value as the absolute value of the difference in distance becomes larger. When the controller 100 ends the execution of the process of step S402, the controller 100 executes the process of step S403.

In step S403, the controller 100 transmits, to the electronic sideview mirror device 70, a change command for increasing or reducing the angle of view of the target image. The change command in this case includes the increase ratio or the reduction ratio set in step S402. When such a change command is received by the electronic sideview mirror device 70, the angle of view of the side camera 710 or 720 that is photographing the target image is increased or reduced according to the increase ratio or the reduction ratio included in the change command. That is, the angle of view of the target image is increased or reduced by an amount according to the operation amount of the pinching operation. When the controller 100 ends the execution of the process of step S403, the controller 100 executes the processes of step S104 and the subsequent steps again.

When the determination in step S401 is in the negative, the controller 100 executes the process of step S404. In step S404, the controller 100 executes information processing for changing the photographing direction of the target image. Specifically, the controller 100 executes the same processes as in steps S107 to S109 in FIG. 9.

Modified Example 3 allows the driver to intuitively adjust the angle of view, in addition to the photographing direction, of the target image that is one of the left sideview mirror image and the right sideview mirror image by performing a touch operation on the target display that is one of the inner display 22 and the outer display 23, in the state of being seated in the driver seat 2. Moreover, the driver can adjust the photographing direction and the angle of view of the target image while checking the target image displayed on the target display from up close. This makes it also easy for the driver to finely adjust the photographing direction and the angle of view of the target image. As a result, the operability of the electronic sideview mirror device 70 can be further improved.

### Modified Example 4

In the above-described embodiment, the example has been described in which the adjustment screen for the left sideview mirror image is displayed on the inner display 22 and the adjustment screen for the right sideview mirror image is displayed on the outer display 23. However, both the adjustment screen for the left sideview mirror image and the adjustment screen for the right sideview mirror image may be displayed on the outer display 23. In that case, when the driver adjusts the left sideview mirror image, information about convenience for occupants of the vehicle 1 can be displayed on the inner display 22.

### Modified Example 5

In the above-described embodiment, the example has been described in which the adjustment screen for the left sideview mirror image is displayed on the inner display 22 when the GUI part G110 is selected in the setting screen as illustrated in FIG. 6, and the adjustment screen for the right sideview mirror image is displayed on the outer display 23 when the GUI part G120 is selected in the setting screen as illustrated in FIG. 6. On the other hand, displaying the adjustment screen for the left sideview mirror image on the inner display 22 and displaying the adjustment screen for the right sideview mirror image on the outer display 23 may be performed at the same time. In that case, instead of the GUI parts G110 and G120 in FIG. 6, a GUI part for simultaneously adjusting the left sideview mirror image and the right sideview mirror image should be displayed in the setting screen of the electronic sideview mirror device 70. Upon this GUI part being selected, the controller 100 should display the adjustment screen for the left sideview mirror image on the inner display 22 and at the same time display the adjustment screen for the right sideview mirror image on the outer display 23. This eliminates the need for the driver to perform an operation of separately calling up the adjustment screen for the left sideview mirror image and the adjustment screen for the right sideview mirror image. As a result, convenience for the driver can be enhanced.

### Modified Example 6

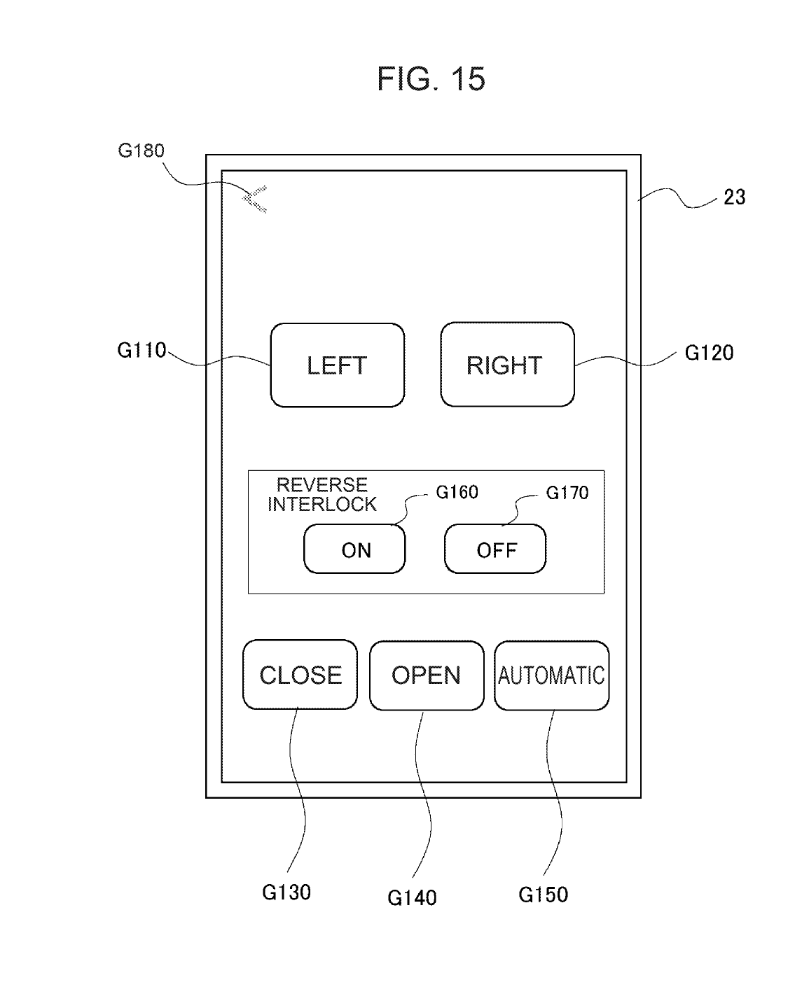

In addition to the functions in the above-described embodiment, the ECU 10 may be configured to have a function of switching between on and off of reverse interlock according to the user's touch operation. That is, the controller 100 of the ECU 10 may be configured to display a screen as shown in FIG. 15 on the outer display 23 as the setting screen of the electronic sideview mirror device 70.

The setting screen shown in FIG. 15 includes GUI parts G160 and G170 for selecting on or off of reverse interlock in addition to the GUI part G110 for calling up the adjustment screen for the left sideview mirror image, the GUI part G120 for calling up the adjustment screen for the right sideview mirror image, the GUI part G130 for closing (folding) the side cameras 710, 720, the GUI part G140 for opening (deploying) the side cameras 710, 720, the GUI part G150 for automatically opening and closing (deploying and folding) the side cameras 710, 720, and the GUI part G180 for returning to the menu screen.

The reverse interlock is a function of switching the left sideview mirror image and/or the right sideview mirror image to an image for reversing upon a shift position of the vehicle 1 having been changed to a reverse range. In one example, the image for reversing may be an image in which the photographing direction of the left sideview mirror image and/or the right sideview mirror image has been changed to the downward direction by a predetermined amount from the photographing direction when the shift position is in a range other than the reverse range. In another example, the image for reversing may be an image in which the angle of view of the left sideview mirror image and/or the right sideview mirror image has been increased by a predetermined ratio from the angle of view when the shift position is in a range other range than the reverse range.

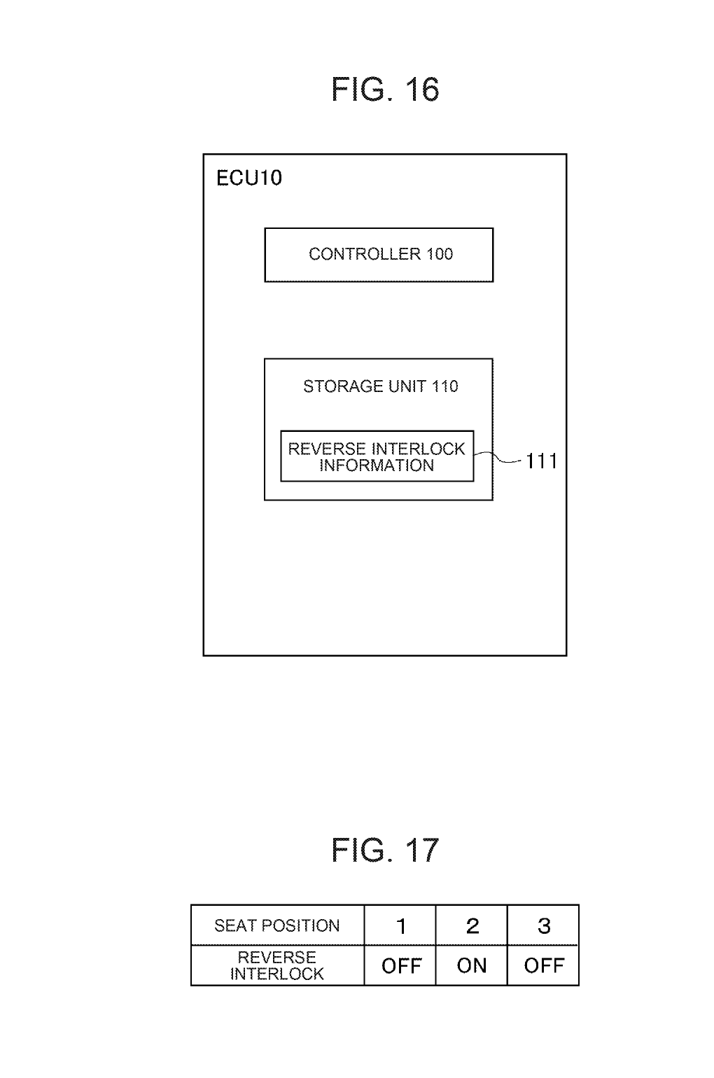

Some users find it difficult to drive with the above-described reverse interlock on. In this modified example, therefore, the user can select on or off of the reverse interlock in the setting screen as illustrated in FIG. 15. When either the GUI part for turning the reverse interlock on (G160 in FIG. 15) or the GUI part for turning the reverse interlock off (G170 in FIG. 15) has received the user's touch operation in the setting screen illustrated in FIG. 15, the controller 100 stores information corresponding to the GUI part that has received the touch operation (information for turning the reverse interlock on or off (reverse interlock information 111)) in the storage unit 110 of the ECU 10 (see FIG. 16).

As shown in FIG. 17, the reverse interlock information 111 may be stored in the storage unit 110 in a form of being linked to the seat positions of the driver seat 2. The term "seat position" means a seat position that is registered in a memory function of the electrically powered seat of the driver seat 2. The seat positions "1," "2," and "3" in FIG. 17 correspond to the seat positions registered in "No. 1," "No. 2," and "No. 3," respectively, of the memory function. In the example shown in FIG. 17, for the reverse interlock information 111 corresponding to the seat position "1," information for turning the reverse interlock off ("OFF" in FIG. 17) is registered. This shows that a first user who has selected "No. 1" of the memory function of the electrically powered seat has performed a touch operation on the GUI part G170 in the setting screen of FIG. 15. For the reverse interlock information 111 corresponding to the seat position "2," information for turning the reverse interlock on ("ON" in FIG. 17) is registered. This shows that a second user who has selected "No. 2" of the memory function of the electrically powered seat has performed a touch operation on the GUI part G160 in the setting screen of FIG. 15. Further, for the reverse interlock information 111 corresponding to the seat position "3," information for turning the reverse interlock off ("OFF" in FIG. 17) is registered. This shows that a third user who has selected "No. 3" of the memory function of the electrically powered seat has performed a touch operation on the GUI part G170 in the setting screen of FIG. 15.

In the vehicle 1 in this modified example, when the shift position of the vehicle 1 is changed from a range other than the reverse range to the reverse range, the controller 100 acquires the seat position of the driver seat 2 through the seat position sensor included in the sensor cluster 9. Subsequently, the controller 100 accesses the reverse interlock information 111 in the storage unit 110 using the acquired seat position as an argument, and determines whether the reverse interlock information 111 corresponding to that seat position is "on." When the reverse interlock information 111 is "on," the controller 100 transmits, to the electronic sideview mirror device 70, a command for switching the left sideview mirror image and/or the right sideview mirror image to the image for reversing. Thereafter, when the shift position of the vehicle 1 is changed from the reverse range to a range other than the reverse range, the controller 100 transmits, to the electronic sideview mirror device 70, a command for switching the left sideview mirror image and/or the right sideview mirror image from the image for reversing to the original image. When the reverse interlock information 111 is "off," the controller 100 does not transmit, to the electronic sideview mirror device 70, a command for switching the left sideview mirror image and/or the right sideview mirror image to the image for reversing.

Modified Example 6 allows the driver of the vehicle 1 to select and register on or off of the reverse interlock in the setting screen of the electronic sideview mirror device 70. In particular, when the vehicle 1 is shared among a plurality of users, each user can select and register different reverse interlock information 111. This eliminates the need to select and register "on" or "off" of the reverse interlock again each time the user who drives the vehicle 1 changes. Therefore, the operability of the electronic sideview mirror device 70 can be further improved.

### Others

The above-described embodiment and modified examples are merely examples, and the present disclosure can be implemented with changes made thereto as appropriate within such a range that no departure is made from the gist of the disclosure. The processes and means described in the above-described embodiment and modified examples can be implemented in arbitrary combinations within such a range that no technical inconsistency arises. A process that has been described as being performed by one device may be shared and executed by a plurality of devices. Alternatively, processes that have been described as being performed by different devices may be executed by one device. What hardware configuration is used to realize each function in the computer system can be flexibly changed.

In the above-described embodiment, the example has been described in which the ECU 10 of the vehicle 1 functions as the information processing device. However, the present disclosure is not limited thereto, and, for example, the user's mobile terminal may function as the information processing device, or an external server may function as the information processing device.

The present disclosure can also be realized by supplying a computer program equipped with the functions described in the above-described embodiment or modified examples to a computer and making one or more processors belonging to the computer retrieve and execute the program. Such a computer program may be provided to a computer by a non-transitory computer-readable storage medium that can be connected to a system bus of the computer, or may be provided to a computer through a network. Examples of non-transitory computer-readable storage media include arbitrary types of discs such as magnetic discs (a floppy (R) disk, a hard disc drive (HDD), etc.) and optical discs (a CD-ROM, a DVD disc, a Blu-ray disc, etc.), a read-only memory (ROM), a random-access memory (RAM), an EPROM, an EEPROM, a magnetic card, a flash memory, an optical card, and arbitrary types of media suitable for storing electronic instructions.

What is claimed is:

1. An in-vehicle system comprising:
an electronic sideview mirror device including
a pair of side cameras configured to photograph right and left rear sides of a vehicle, and
a pair of first displays configured to respectively display a pair of sideview mirror images photographed by the side cameras;
a display device including a pair of second displays, the second displays being respectively disposed on lateral sides of a steering wheel so as to protrude farther toward a vehicle rear side than an instrument unit placed on a front side of the steering wheel, and each of the second displays having a touch panel; and
an information processing device including a controller configured to execute
transmitting, to the display device, a command for displaying a target image that is one of the sideview mirror images on a target display that is one of the second displays,
receiving, from the touch panel, a signal about a touch operation on a screen of the target display in a state where the target image is displayed on the target display, and
transmitting, to the electronic sideview mirror device, a command for changing the target image to an image according to the touch operation.

2. An in-vehicle system comprising:
an electronic sideview mirror device including
a pair of side cameras configured to photograph right and left rear sides of a vehicle, and
a pair of first displays configured to respectively display a pair of sideview mirror images photographed by the side cameras;
a display device including a pair of second displays, the second displays being respectively disposed on lateral sides of a steering wheel so as to protrude farther toward a vehicle rear side than an instrument unit placed on a front side of the steering wheel, and each of the second displays having a touch panel; and
an information processing device including a controller configured to execute
displaying a target image that is one of the sideview mirror images on a target display that is one of the second displays,
detecting a touch operation on a screen of the target display in a state where the target image is displayed on the target display, and
changing the target image to an image according to the touch operation.

3. The in-vehicle system according to claim 2, wherein
the touch operation is an operation of touching a region in the screen of the target display other than a center, and
the changing of the target image to the image according to the touch operation includes
determining a touch direction that is a direction in which a position that has received the touch operation is located with respect to the center in the screen of the target display, and
transmitting, to the electronic sideview mirror device, a command for moving a photographing direction of the target image to the touch direction.

4. The in-vehicle system according to claim 2, wherein
the touch operation is an operation of swiping on the screen of the target display, and
the changing of the target image to the image according to the touch operation includes
determining a sliding direction of the touch operation, and
transmitting, to the electronic sideview mirror device, a command for moving a photographing direction of the target image to an opposite direction from the sliding direction.

5. The in-vehicle system according to claim 2, wherein
the displaying of the target image on the target display includes displaying an image in which two or more graphical user interface (GUI) parts for changing a photographing direction of the target image are superimposed on the target image,
the touch operation is an operation of touching one of the two or more GUI parts, and
the changing of the target image to the image according to the touch operation includes
determining the GUI part that has been selected by the touch operation, and
transmitting, to the electronic sideview mirror device, a command for moving the photographing direction of the target image to a direction corresponding to the determined GUI part.

6. The in-vehicle system according to claim 2, wherein
the touch operation is an operation of pinching in or pinching out on the screen of the target display, and
the changing of the target image to the image according to the touch operation includes
determining an operation amount of the pinching in or the pinching out, and
transmitting, to the electronic sideview mirror device, a command for increasing or reducing an angle of view of the target image to an angle of view according to the determined operation amount.

7. The in-vehicle system according to claim 2, wherein
the information processing device further includes a memory configured to contain reverse interlock information, the reverse interlock information being information about on or off of reverse interlock that switches the target image to an image for reversing in response to a shift position of the vehicle having been changed to a reverse range, and
the controller is configured to further execute
displaying a screen for selecting on or off of the reverse interlock on one of the second displays, and
storing a selection result of on or off of the reverse interlock in the memory as the reverse interlock information.

8. An information processing device installed in a vehicle, comprising a controller, wherein
the vehicle includes
an electronic sideview mirror device including
a pair of side cameras configured to photograph right and left rear sides of the vehicle, and
a pair of first displays configured to respectively display a pair of sideview mirror images photographed by the side cameras, and
a display device including a pair of second displays, the second displays being respectively disposed on lateral sides of a steering wheel so as to protrude farther toward a vehicle rear side than an instrument unit placed on a front side of the steering wheel, and each of the second displays having a touch panel,
the controller is configured to execute
displaying a target image that is one of the sideview mirror images on a target display that is one of the second displays,
detecting a touch operation on a screen of the target display in a state where the target image is displayed on the target display, and
changing the target image to an image according to the touch operation.

9. The information processing device according to claim 8, wherein
the touch operation is an operation of touching a region in the screen of the target display other than a center, and
the changing of the target image to the image according to the touch operation includes
determining a touch direction that is a direction in which a position that has received the touch operation is located with respect to the center in the screen of the target display, and
transmitting, to the electronic sideview mirror device, a command for moving a photographing direction of the target image to the touch direction.

10. The information processing device according to claim 8, wherein
the touch operation is an operation of swiping on the screen of the target display, and
the changing of the target image to the image according to the touch operation includes
determining a sliding direction of the touch operation, and
transmitting, to the electronic sideview mirror device, a command for moving a photographing direction of the target image to an opposite direction from the sliding direction.

11. The information processing device according to claim 8, wherein
the displaying of the target image on the target display includes displaying an image in which two or more graphical user interface (GUI) parts for changing a photographing direction of the target image are superimposed on the target image,
the touch operation is an operation of touching one of the two or more GUI parts, and
the changing of the target image to the image according to the touch operation includes
determining the GUI part that has been selected by the touch operation, and
transmitting, to the electronic sideview mirror device, a command for moving the photographing direction of the target image to a direction corresponding to the determined GUI part.

12. The information processing device according to claim 8, wherein
the touch operation is an operation of pinching in or pinching out on the screen of the target display, and
the changing of the target image to the image according to the touch operation includes
determining an operation amount of the pinching in or the pinching out, and
transmitting, to the electronic sideview mirror device, a command for increasing or reducing an angle of view of the target image to an angle of view according to the determined operation amount.

13. The information processing device according to claim 8, further comprising a memory configured to contain reverse interlock information, the reverse interlock information being information about on or off of reverse interlock that switches the target image to an image for reversing in response to a shift position of the vehicle having been changed to a reverse range, wherein the controller is configured to further execute
displaying a screen for selecting on or off of the reverse interlock on one of the second displays, and
storing a selection result of on or off of the reverse interlock in the memory as the reverse interlock information.
